(19) United States
(12) Patent Application Publication
(10) Pub. No.: US 2026/0116827 A1
(43) Pub. Date: Apr. 30, 2026

(54) Application of Coal-based Nanomaterials in Cement Composites

(71) Applicant: United States Department of Energy, Washington, DC (US)

(72) Inventors: Christopher Matranga, Pittsburgh, PA (US); Barbara Kutchko, Upper St. Clair, PA (US); Yuan Gao, Upper St. Clair, PA (US); Viet Hung Pham, Venetia, PA (US); Congjun Wang, Bethel Park, PA (US); Jennifer Weidman, South Park, PA (US)

(21) Appl. No.: 18/933,638

(22) Filed: Oct. 31, 2024

(51) Int. Cl. C04B 35/52; B82Y 30/00; C04B 35/622; C04B 35/64

(52) U.S. Cl. CPC C04B 35/52; B82Y 30/00; C04B 35/62204; C04B 35/64

(57) ABSTRACT

A method of using a coal-derived carbon nanomaterial to enhance the physical properties of cement, featuring: mixing an amount of the coal-derived carbon nanomaterial and a cement formulation, forming a cement suspension, where the carbon nanomaterial includes carbon dots, non-oxidized carbon nanoflakes, oxidized nanoflakes, and combinations of the above; and curing the cement suspension, forming an enhanced cement. An enhanced cement featuring a coal-derived carbon nanomaterial and a cement formulation, where the coal-derived nanomaterial includes carbon dots, non-oxidized carbon nanoflakes, oxidized nanoflakes, and combinations of the above.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory.

### FIELD OF THE INVENTION

Embodiments relate to methods for using coal-derived carbon nanomaterials for cement additive applications. More specifically, embodiments relate methods of using coal-derived carbon nanomaterials as cement additives to enhance the physical properties of cement, with said carbon nanomaterials providing the cement increased compressive strength, increased flexural strength, and increased durability via decreased permeability, compared to those of conventional cements without nanomaterial additives. Further embodiments relate to an enhanced cement featuring a coal-derived carbon nanomaterial and a cement formulation.

### BACKGROUND

Cement composites, including cement paste, mortar, and concrete, are some of the most widely used construction materials in the world. However, their quasi-brittle nature, susceptibility to cracking, low toughness, and low tensile strength have been identified as the main characteristics that result in poor durability and high maintenance costs. Traditional methods to enhance the strength and durability of the cement matrix include the incorporation of reinforcement materials (e.g., steel rebars, macro/microfibers), use of chemical mineral admixtures (e.g., silica fume), or reduction of water-to-binder ratio. In the past decade, the use of nanomaterials in cement composites has received considerable attention. Nanomaterials have the potential to control nanoscale cracks, which can prevent their growth and formation of micro-, or even larger-scale, defects.

The demand for conventional and high performance cements continues to grow with an increasing need for cement materials that can withstand extreme operating conditions found in demanding applications, such as in wellbore materials for oil wells and in high performance concrete materials for bridges and high-rise buildings. The cement industry faces ongoing challenges related to enhancing the strength, durability, and resistance of cement in these demanding environments. Simultaneously, the coal industry has been experiencing a significant decline due to reduced demand from the power sector, with coal production dropping from around 1.2 billion tons in 2007-2008 to approximately 0.7 billion tons in 2020. Coal is a carbon-rich feedstock and has been used to produce carbon nanomaterials with different techniques, such as chemical oxidation, chemical vapor deposition (CVD), and flash Joule heating. Low rank coals have poorly aligned aromatic carbon structures, while high rank coals have carbon lattices with more ordered and layered structures. For this reason, select coal types could be candidates for the large-scale production of carbon nanomaterials using simple mechanical exfoliation methods such as those described in embodiments of the invention herein. In addition, the abundance and low-cost of coal makes it suitable for the large markets associated with manufacturing carbon-enhanced composites for construction applications. Embodiments of the invention described herein are low-cost and abundant coal feedstock-derived carbon nanomaterial cement additives, and methods of making the same, which not only improve the performance of cement by increasing its strength and reducing its susceptibility to extreme conditions, but also may provide a new avenue for coal utilization from the coal industry which has traditionally depended primarily on the power generation market.

Hydration, filling, and bonding are the major intrinsic factors influencing the mechanical properties and durability of cement-based materials. Carbon additives have been shown to impact these factors and enhance the properties of cement composites. In efforts to increase strength and performance of conventional and high performance cements, a variety of cement additives are commonly used in the cement production process. Generally, conventional concrete costs approximately $100 per cubic yard, and high performance concrete, used in the most-demanding infrastructure projects, costs approximately $500 per cubic yard, at baseline. Commercially available cement additives include graphite feedstock-derived nanomaterials, silica fume, and carbon fiber, however these additives are costly. Generally, approximately 0.3 pounds at 0.025 wt. % loading of a carbon-based nanomaterial would be required to improve the strength of one cubic yard of conventional concrete. For conventional concrete applications, commercially available graphite feedstock-derived carbon nanomaterial additives would increase the cost of the concrete from $100 to $140 per cubic yard, based on the current market pricing of that nanomaterial at $300,000 per ton from XG Sciences, for example. In comparison, adding 5 wt. % of silica fume adds $7 per cubic yard to the cost of conventional concrete and imparts similar strength improvement as the graphite feedstock-derived nanomaterial. Likewise, for high performance concrete applications, manufacturing a cubic yard of the high performance concrete would generally require about 0.6 lbs of a carbon-based nanomaterial to improve the strength of one cubic yard. Here, commercial graphite feedstock-derived carbon nanomaterial additives in high-performance concrete would increase cost from $500 to $580 per cubic yard. Carbon fiber additives are even more expensive and would bring the cost to about $850 per cubic yard of high-performance concrete.

Embodiments of the invention described herein describe scalable methods of making and methods of using a low-cost, coal feedstock derived carbon nanomaterial additive which achieves strength enhancement of concrete comparable to or exceeding silica fume, commercial graphite-derived nanomaterials, and carbon fiber additives, but at a much lower cost. In an embodiment, the coal-derived carbon nanomaterial additive described by the invention herein increases the cost of conventional concrete by only about $4 per cubic yard, which is cheaper than the $7 increase for using commercial silica fume and the $40 increase for using conventional commercial graphite-derived nanomaterials. Similarly, in an embodiment, the coal-derived carbon nanomaterial additive increases the cost of high-performance concrete by about $8 per cubic yard for a total of $508 per cubic yard, which is vastly lower than those using either conventional commercial graphite-derived nanomaterial ($580/cubic yard) or carbon fiber ($850/cubic yard) additive.

In embodiments of the invention described herein, the coal-based carbon nanomaterial additive increases the mechanical compressive & flexural strengths of cement. In embodiments, the coal-based carbon nanomaterial additive reduces the cement's permeability, which improves the cement's resistance to extreme operation conditions, including a wide temperature range and exposure to corrosive chemicals and gases. In embodiments, the improvements in the concrete's strength and resistance to extreme operation conditions allow the cement to be used in more demanding applications, such as in wellbore materials for drilling applications and in high performance construction and infrastructure materials.

A need exists in the art for cheaper cement additives that increase cement's compressive strength, flexural strength, and durability that overcomes the disadvantages of the prior art. The novel method and principles of operation are further discussed in the following description.

### SUMMARY

Embodiments of the invention provide a method of using coal-derived carbon nanomaterials to enhance physical properties of cement. The method includes mixing an amount of the coal-derived carbon nanomaterial and a cement formulation, forming a cement suspension, wherein the carbon nanomaterial is selected from the group consisting of: carbon dots, non-oxidized carbon nanoflakes, oxidized nanoflakes, and combinations thereof; and curing the cement suspension, forming an enhanced cement.

More specifically, embodiments of the invention describe the method of using coal-derived carbon nanomaterials to enhance physical properties of cement, wherein the enhanced cement features an increase in compressive strength of between about 4% to about 24% compared to a cement formulation without the coal-derived carbon nanomaterial, an increase in flexural strength of between about 2% to about 22% compared to a cement formulation without the coal-derived carbon nanomaterial, a decreased permeability of between about 35% to about 86% compared to a cement formulation without the coal-derived carbon nanomaterial, and a decreased chloride penetration depth of between about 40% to about 60% compared to a cement formulation without the coal-derived carbon nanomaterial.

Embodiments of the invention also provide an enhanced cement comprising a coal-derived carbon nanomaterial and a cement formulation, wherein the coal-derived nanomaterial is selected from the group consisting of carbon dots, non-oxidized carbon nanoflakes, oxidized nanoflakes, and combinations thereof.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 is a flowchart for a method of using coal-derived carbon nanomaterials for cement additive applications, in accordance with the features of the present invention;

FIG. 2 is a flowchart for a method of producing coal-derived carbon nanomaterials for cement additive applications, in accordance with the features of the present invention;

FIG. 3 is a flowchart for a method of producing a coal-derived carbon nanomaterial to enhance the physical properties of cement, in accordance with the features of the present invention;

FIG. 4A is a cross-sectional SEM image of ground coal char, in accordance with the features of the present invention;

FIG. 4B is a cross-sectional SEM image of ground coal char, in accordance with the features of the present invention;

FIG. 5A is a cross-sectional SEM image of ground and ball-milled coal char, in accordance with the features of the present invention;

FIG. 5B is a cross-sectional SEM image of ground and ball-milled coal char, in accordance with the features of the present invention;

FIG. 6 is a SEM image of Blue Gem coal char precursor used for the synthesis of carbon nanomaterials, wherein the scale bar is 20 μm, in accordance with the features of the present invention;

FIG. 7 is a SEM image of Blue Gem coal char precursor used for the synthesis of carbon nanomaterials, wherein the scale bar is 3 μm, in accordance with the features of the present invention;

FIG. 8 is a graph showing thermogravity analysis (TGA) in air of Blue Gem coal char precursor, in accordance with the features of the present invention;

FIG. 9 is a graph showing XRD profiles of Blue Gem coal char precursor and commercial graphite, in accordance with the features of the present invention;

FIG. 10 is a flowchart showing exemplary methods of synthesis of coal-based carbon nanomaterial additives, in accordance with the features of the present invention;

FIG. 11 is a TEM image of coal-based carbon quantum dots (C1), wherein the arrows therein highlight the quantum dots, and wherein the scale bar is 10 nm, in accordance with the features of the present invention;

FIG. 12 is a TEM image of coal-based non-oxidized carbon nanoflakes (C2), wherein the scale bar is 100 nm, in accordance with the features of the present invention;

FIG. 13 is a TEM image of coal-based oxidized carbon nanoflakes (C3), wherein the scale bar is 100 nm, in accordance with the features of the present invention;

FIG. 14 is a SEM image of coal-based non-oxidized carbon nanoflakes (C2), wherein the scale bar is 2 μm, in accordance with the features of the present invention;

FIG. 15 is a SEM image of coal-based oxidized carbon nanoflakes (C3), wherein the scale bar is 2 μm, in accordance with the features of the present invention;

FIG. 16 is a graph showing the compressive strength improvement of cement with the addition of different coal-based carbon nanomaterials at different loadings compared to the control sample (neat cement), in accordance with the features of the present invention;

FIG. 17 is a graph showing the compressive strength improvement of cement with the addition of different coal-based carbon nanomaterials at different loadings compared to the control sample (neat cement), in accordance with the features of the present invention;

FIG. 18 is a graph showing the flexural strength improvement of cement with the addition of different coal-based carbon nanomaterials at different loadings compared to the control sample (neat cement), in accordance with the features of the present invention;

FIG. 19 is a graph showing the flexural strength improvement of cement with coal-based non-oxidized carbon nanoflakes (C2) at different loadings compared to the control sample (neat cement), in accordance with the features of the present invention;

FIG. 20A is a graph showing the porosity of cement samples with different coal-based carbon nanomaterials at different loadings as well as control neat cement and commercial GO-added cement, in accordance with the features of the present invention;

FIG. 20B is a graph showing the permeability of cement samples with different coal-based carbon nanomaterials at different loadings as well as control neat cement and commercial GO-added cement, in accordance with the features of the present invention;

FIG. 21 are photographs of chloride penetration test samples with neat control cement, and cement composite with carbon additives at different loadings, in accordance with the features of the present invention;

FIG. 22 is a graph showing chloride penetration depth of cement pastes with three different coal-based carbon nanomaterial additives as well as control neat cement and commercial GO-added sample, in accordance with the features of the present invention;

FIG. 23 is a graph showing the compressive strength improvement of cement mixture 1 (normal strength concrete) with the addition of different coal-based carbon nanomaterials at different loadings compared to the control sample (neat cement), in accordance with the features of the present invention;

FIG. 24 is a graph showing the compressive strength improvement of cement mixture 2 (high strength concrete) with the addition of different coal-based carbon nanomaterials at different loadings compared to the control sample (neat cement), in accordance with the features of the present invention;

FIG. 25 is a graph showing the flexural strength improvement of cement mixture 1 (normal strength concrete) with the addition of different coal-based carbon nanomaterials at different loadings compared to the control sample (neat cement), in accordance with the features of the present invention;

FIG. 26 is a graph showing the flexural strength improvement of cement mixture 2 (high strength concrete) with the addition of different coal-based carbon nanomaterials at different loadings compared to the control sample (neat cement), in accordance with the features of the present invention;

FIG. 27 is graph of an XRD pattern of cement pastes with three different coal-based carbon nanomaterial additives as well as control neat cement and commercial GO added samples, in accordance with the features of the present invention;

FIG. 28A is a graph of a differential scanning calorimetry (DSC) curve of cement pastes with three different coal-based carbon nanomaterial additives as well as control neat cement and commercial GO added samples, wherein the boxes highlight the three temperature ranges where significant reactions occur, and wherein the inset in shows more details during the decomposition of Portlandite, in accordance with the features of the present invention;

FIG. 28B is an inset of the graph of the DSC curve in FIG. 28A showing further details of decomposition of Portlandite, where the X axis is temperature (° C.) and the Y-axis is heat flow (mW/mg), in accordance with the features of the present invention;

FIG. 29 is a graph of a thermogravimetry analysis (TGA) curve of cement pastes with three different coal-based carbon nanomaterial additives as well as control neat cement and commercial GO added samples, wherein the boxes highlight three temperature ranges where significant reactions occur, in accordance with the features of the present invention;

FIG. 30 is a graph showing mass loss of the hydration products for samples at 28 days of cure relative to the dry mass at 1000° C., in accordance with the features of the present invention;

FIG. 31A is a TEM image of non-oxidized carbon nanoflakes C2, in accordance with the features of the present invention;

FIG. 31B is a TEM image of non-oxidized carbon nanoflakes C2, in accordance with the features of the present invention;

FIG. 32A is a TEM image of oxidized carbon nanoflakes C3, in accordance with the features of the present invention; and

FIG. 32B is a TEM image of non-oxidized carbon nanoflakes C3, in accordance with the features of the present invention.

### DETAILED DESCRIPTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

As used herein, cement and concrete are equivalent and may be used interchangeably.

Embodiments of the invention herein describe three kinds of carbon nanomaterials from coal feedstocks that are produced using three different synthesis methods, where their properties are assessed for enhanced cementitious composites. In embodiments of the invention, the three carbon nanomaterials are carbon dots (referred to as “C1” herein), non-oxidized carbon nanoflakes (referred to as “C2” herein), and oxidized carbon nanoflakes (referred to as “C3” herein), where lateral sizes, elemental compositions, and a comparison of the nanomaterials are summarized in Tables 1, 2, and 3 below, respectively.

TABLE 1
Lateral sizes (nm) of C2 and C3

| Object | | |
|---|---|---|
| number | | |
| (arbitrary) | C2 | C3 |
| 1 | 78 | 78 |
| 2 | 108 | 83 |
| 3 | 113 | 88 |
| 4 | 136 | 123 |
| 5 | 149 | 131 |
| 6 | 152 | 136 |
| 7 | 165 | 157 |
| 8 | 173 | 167 |
| 9 | 179 | 164 |
| 10 | 183 | 172 |
| 11 | 183 | 177 |
| 12 | 195 | 188 |
| 13 | 211 | 189 |
| 14 | 220 | 187 |
| 15 | 236 | 207 |
| 16 | 292 | 219 |
| 17 | 332 | 219 |
| 18 | 339 | 231 |
| 19 | 352 | 243 |
| 20 | 365 | 257 |
| 21 | 365 | 259 |
| 22 | 395 | 331 |
| 23 | 613 | 361 |
| 24 | 796 | 368 |
| 25 | | 368 |
| 26 | | 380 |
| 27 | | 384 |
| 28 | | 408 |
| 29 | | 431 |
| Mean | 264 | 231 |
| STD | 162.5 | 102.8 |

TABLE 2
Elemental Composition of C1, C2,
C3, and commercial Graphene Oxide

| | | | | GO |
|---|---|---|---|---|
| | | | | (from |
| | | | | Graphenea |
| | C1 | C2 | C3 | Inc.) |
| Elemental | C-62.9% | C-93.6% | C-91.38% | C-49-56% |
| Composition | O-35.0% | O-5.0% | O-6.82% | O-41-50% |
| (atomic %) | Fe-0.8% | Al-0.9% | Al-0.47% | S-2-3% |
| | Al-0.6% | Si-0.2% | Ca-0.53% | H-0-1% |
| | Si-0.5% | S-0.2% | S-0.37% | N-0-1% |
| | S-0.3% | Fe-0.1% | Si-0.22 | |

TABLE 3
Comparison of Coal-based Carbon Nanomaterials*

| | C1 | C2 | C3 |
|---|---|---|---|
| Lateral Size (nm) | 2-4 | 70-500 | 70-500 |
| Carbon Layers | 1 | 3-5 | 3-7 |
| Aspect Ratio | 2-4 | 50-100 | 50-100 |
| C/O Ratio | 1.92 | 30.2 | 18.8 |

*The lateral size and carbon layers in Table 3 are based on statistical TEM analysis. The C/O ratio is based on XPS analysis.

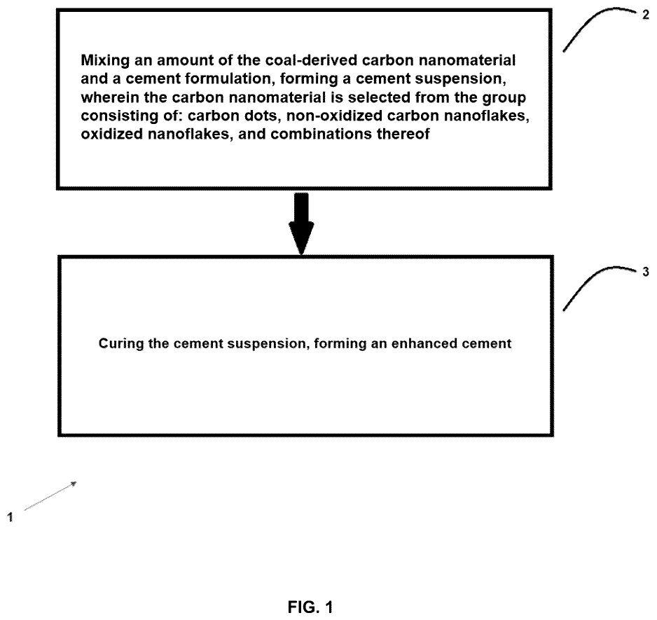

FIG. 1 depicts a flowchart for a method 2 of using a coal-derived carbon nanomaterial to enhance the physical properties of cement. The method 2 begins by mixing a predetermined amount of the coal-derived carbon nanomaterial and a cement formulation, forming a cement suspension 3. In embodiments, the coal-derived carbon nanomaterial is selected from the group consisting of non-oxidized carbon nanoflakes, oxidized nanoflakes, carbon dots, and combinations thereof. A person having ordinary skill in the art will readily understand that this list is exemplary and not meant to be limiting. A salient feature of the invention is that, in embodiments, in step 3, the coal-derived carbon nanomaterial is mixed with the cement formulation without adding water.

In an embodiment, the carbon nanomaterial is derived from coal. In an embodiment, the coal is selected from the group consisting of: bituminous coal, anthracitic coal, beneficiated forms of bituminous and anthracitic coal, and combinations thereof. A person having ordinary skill in the art will readily understand that this list is exemplary and not meant to be limiting. In an embodiment, the carbon nanomaterial is derived from processed coal products selected from the group consisting of: raw coal char, lignite, coal tar, coal pitch, coke, coal fines, carbon-based coal-byproducts, and combinations thereof. A person having ordinary skill in the art will readily understand that this list is exemplary and not meant to be limiting. In embodiments, the carbon nanomaterials used in method 2 are generated according to the methods 5 and/or 10 described herein.

In an embodiment, the cement formulation is a conventional or high performance cement formulation. In embodiments, exemplary cement paste, referred to as “cement formulation” in method 2, was prepared by combining water with dry cement powder, with a water-to-cement ratio of 0.2, and mixed and cured for 28 days according to the ASTM 305. In further embodiments, exemplary concrete formulations were prepared with mix ratios shown in Table 4 in the Examples. In embodiments, mix 1 only contains water, sand, and coarse aggregate, which simulates a normal-strength concrete with the compressive strength less than 6000 psi. In embodiments, mix 2 has a lower water to cement ratio at 0.32, and is absent of coarse aggregate, and 5 wt. % of silica fume is added to improve the compressive strength. In embodiments, mix 2 simulates a high-strength concrete with the compressive strength more than 6000 psi. These cement formulations are exemplary, are readily understood by a person having ordinary skill in the art, and are not meant to be limiting.

Advantageously, in embodiments, the coal-derived carbon nanomaterials are deployed as a “single step” additive, where it is added directly to conventional cement formulations to improve their performance and does not require additional technologies, methods, or training for use.

Returning to the FIG. 1, method 2 continues with curing the cement suspension, forming an enhanced cement 4. In an embodiment, curing the cement suspension comprises any process of curing the respective cement formulation readily understood by a person having ordinary skill in the art and is not meant to be limiting.

In embodiments, the amount of carbon nanomaterial mixed with the cement formulation in step 3 is such that the cement suspension produced via method 2 comprises approximately 0.005 wt. % to approximately 0.5 wt. % carbon nanomaterial, more preferably between approximately 0.01 wt. % and approximately 0.1 wt. % carbon nanomaterial, and typically between approximately 0.01 wt. % and approximately 0.07 wt. % carbon nanomaterial.

Notably, in embodiments, the enhanced cement comprising the carbon nanomaterials features enhanced compressive strength. In embodiments, the enhanced cement comprises an increase in compressive strength of between about 4% to about 24% compared to a cement generated from a cement formulation without the coal-derived carbon nanomaterial. In an embodiment, the carbon nanomaterials facilitate enhanced compressive strength through a nano filler effect which densifies the microstructure of the enhanced cement.

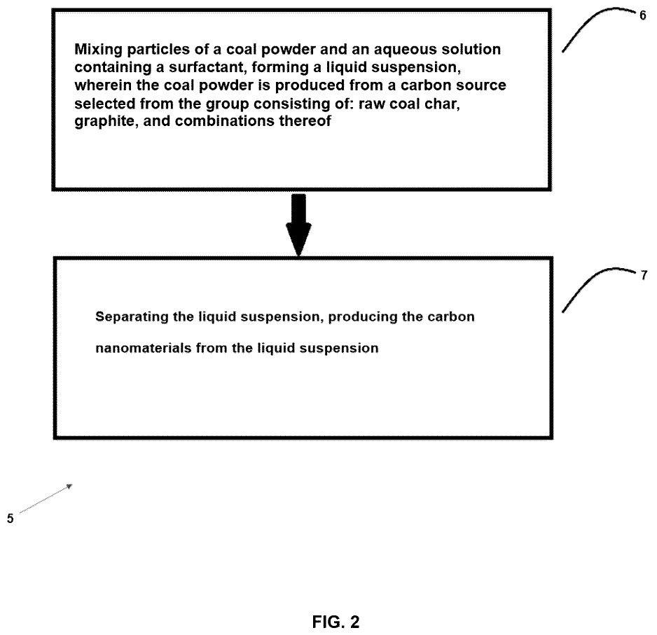

FIG. 2 depicts a flowchart for a method 5 of producing coal-derived carbon nanomaterials for cement additive applications. The method 5 begins by mixing particles of a coal powder with an aqueous solution containing a surfactant, forming a liquid suspension 6.

In the first step of method 5 shown in FIG. 2, particles of a coal powder and an aqueous solution are mixed, wherein the aqueous solution comprises a surfactant, and wherein the coal powder is produced from a carbon source selected from the group consisting of raw coal char, graphite, and combinations thereof. In further embodiments, the carbon source is selected from bituminous coal, anthracitic coal, beneficiated forms of bituminous and anthracitic coal, lignite, coal tar, coal pitch, coke, coal fines, carbon-based coal-byproducts, and combinations thereof. A person having ordinary skill in the art will readily understand that this list is exemplary and not meant to be limiting. In some embodiments, raw coal char with or without oxidation is used as a carbon source to produce the particles of coal powder. In some embodiments, particles of coal powder are oxidized or have not been oxidized.

In an embodiment, the particles of coal powder are produced from the carbon source utilizing a mechanical grinding treatment selected from ball milling, air milling, air jet milling, wet milling, rotating blade grinding, shatterbox grinding, and combinations thereof. A person having ordinary skill in the art will readily understand that this list is exemplary and not meant to be limiting.

In an embodiment, the coal powders are about 1 micron to about 5 microns in size.

In some embodiments, particles of coal powder that are oxidized are synthesized by exposing coal powders that have not been oxidized with an acid selected from sulfuric acid, nitric acid, and combinations thereof, to form oxidized coal char. A person having ordinary skill in the art will readily understand that this list is exemplary and not meant to be limiting. In some embodiments, the oxidized coal char is acid washed and dried to form oxidized particles of coal powder.

In an embodiment, in step 6, the coal powder is mixed in an aqueous solution comprising water and a surfactant, also known as a superplasticizer. In embodiments, the surfactant is used to facilitate uniform dispersal of particles in the aqueous solution. In an embodiment, the surfactant is selected from non-ionic surfactants, cationic surfactants, anionic surfactants, amphoteric surfactants, polymeric surfactants, and combination thereof. A person having ordinary skill in the art will readily understand that this list is exemplary and not meant to be limiting. In an embodiment, the surfactant comprises acrylate groups in the backbone and side chains, such as poly(ethylene oxide). In an embodiment, the surfactant is selected from sodium dodecyl sulfate, sodium dodecylbenzene sulfonate, sodium cholate, sodium deoxycholate, and combinations thereof. A person having ordinary skill in the art will readily understand that this list is exemplary and not meant to be limiting.

In an embodiment, the coal powder is mixed in an aqueous solution comprising water and a surfactant using a high-intensity shear mixer for a predetermined time between approximately 2 hours at approximately 5000 RPM and approximately 10000 RPM to form a liquid suspension. In an embodiment, the mixing step 6 of method 2 exfoliates the coal powders into the liquid suspension.

In an embodiment, the surfactant comprises between approximately 0.2 wt % to approximately 1 wt % of the aqueous solution.

Returning to FIG. 2, the method 5 continues with separating the liquid suspension 7, producing the carbon nanomaterials from the liquid suspension. In an embodiment, the separating step 7 is performed using centrifugation. In an embodiment, the centrifugation is conducted in about 60,000 cycles at approximately 500 RPM to 2000 RPM and preferably at about 1000 RPM. In an embodiment, the centrifugation produces the carbon nanomaterials from the liquid suspension and separates and filters the carbon nanomaterials from larger coal particles in the liquid suspension.

In an embodiment, the produced carbon nanomaterials are between approximately 1 nm and approximately 1000 nm and preferably between approximately 70 nm and approximately 500 nm in size. In an embodiment, the range of median sizes of the carbon nanomaterials is between about 70 nm to about 500 nm.

In embodiments, the coal-based carbon nanomaterials produced from method 5 are selected from the group consisting of: non-oxidized carbon nanoflakes, oxidized carbon nanoflakes, and combinations thereof. In embodiments, non-oxidized carbon nanoflakes and oxidized carbon nanoflakes are about 3 to about 7 carbon layer 2-dimensional platelets between about 70 nm to about 500 nm in lateral size.

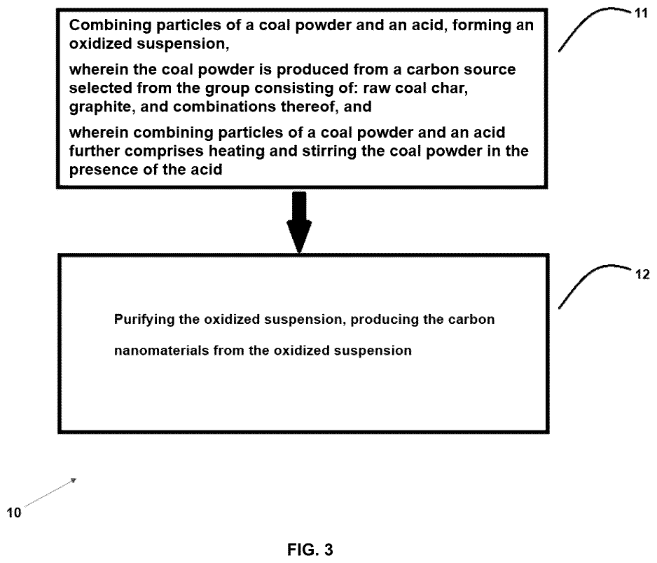

FIG. 3 depicts a flowchart for an additional method 10 of producing coal-derived carbon nanomaterials for cement additive applications. The method 10 begins by combining particles of a coal powder and an acid, forming an oxidized suspension 11. In the first step of method 10 shown in FIG. 3, particles of a coal powder and an acid are combined, wherein the coal powder is produced from a carbon source selected the group consisting of raw coal char, graphite, and combinations thereof. In further embodiments, the carbon source is selected from the group consisting of: bituminous coal, anthracitic coal, beneficiated forms of bituminous and anthracitic coal, lignite, coal tar, coal pitch, coke, coal fines, carbon-based coal-byproducts, and combinations thereof. A person having ordinary skill in the art will readily understand that this list is exemplary and not meant to be limiting. In embodiments, the particles of coal powder are about 5 μm to 50 μm in size.

In an embodiment, the acid is selected from the group consisting of: nitric acid, sulfuric acid, and combinations thereof. In an embodiment, the acid is a mixture of sulfuric acid and nitric acid in a ratio of 3:1 v/v.

In embodiments, the combining particles of the coal powder and the acid step further comprises heating and stirring the coal powder in the presence of the acid. In an embodiment, the heating occurs at a temperature between approximately 100° C. and approximately 150° C. In embodiments, heating the coal powder in concentrated sulfuric and nitric acids initiates exfoliation of nanometer-sized crystalline graphitic domains into small single sheets of graphenic carbon. In an embodiment, the acid treatment described above also oxidizes most of the aliphatic carbon attached to these domains into CO₂ and partially oxidizes the edges of the exfoliated graphenic sheets to form hydroxyl and/or carboxyl functional groups.

Returning to FIG. 3, the method 10 continues with purifying the oxidized suspension, producing the carbon nanomaterials from the oxidized suspension 12. In embodiments, the purifying step comprises neutralizing the oxidized suspension. In an embodiment, neutralizing the oxidized suspension comprises adding a neutralizing solution to the oxidized suspension. In an embodiment, the neutralizing solution comprises a basic aqueous solution, wherein the basic aqueous solution is an aqueous solution containing a base such as sodium hydroxide. A person having ordinary skill in the art will readily comprehend that sodium hydroxide is an exemplary base and not meant to be limiting. In an embodiment, the base comprising the aqueous basic solution is any base suitable for use in the neutralizing step described herein. In an embodiment, the oxidized suspension is diluted with water before neutralizing.

In embodiments, the purifying step comprises filtering the oxidized suspension using cross-flow ultrafiltration, also known as tangential-flow ultrafiltration, to produce the carbon nanomaterials from the oxidized suspension. In an embodiment, the ultrafiltration step uses an about 1.0 kilo Dalton hollow fiber filtration membrane at a pressure of about 8.0 psi, and concentration mode with a concentration factor of about 20.

In embodiments, the size of the carbon nanomaterials produced from method 10 are about 2 nm to 4 nm in size and comprise 1 single carbon layer. In embodiments, the production yield of the carbon nanomaterials produced from method 10 are approximately 10 wt % to approximately 30 wt % of the coal powder. In embodiments, the carbon nanomaterials produced from method 10 comprise carbon dots, also known as carbon quantum dots and graphene quantum dots.

In embodiments, all three coal-based carbon nanomaterials, C1, C2, and C3, improve the compressive strength of enhanced cement (cement formulation). In an embodiment, the enhanced cement comprises an increase in compressive strength by between about 4% to about 24% compared to that of neat cement used as a control sample (cement generated from a cement formulation without added carbon nanomaterials). In comparison, the highest improvement seen for the compressive strength of the commercial graphene oxide samples was about 17% which occurs at the loading of about 0.025 wt. %. In an embodiment, the invented carbon nanomaterial results in greater compressive strength enhancement than that resulting from using a commercial graphene oxide additive at similar loading percentages.

In embodiments, all three coal-based carbon nanomaterials, C1, C2, and C3, demonstrate the ability to improve the compressive strength of concrete mixtures that correspond with normal strength (mix 1) and high-strength (mix 2) concrete described in Table 4 in the Examples. In embodiments, the coal-based carbon nanomaterial additives were able to increase the compressive strength of the concrete mixtures by between about 4% to about 29% compared to control sample concrete mixtures without the coal-based carbon nanomaterial additives.

Notably, in embodiments, the enhanced cement comprising the carbon nanomaterials comprises enhanced flexural strength of enhanced cement (cement formulation). In embodiments, the enhanced cement comprises an increase in flexural strength of between about 2% to about 22% compared to that of neat cement used as a control sample (cement generated from a cement formulation without added carbon nanomaterials). In an embodiment, the carbon nanomaterials facilitate enhanced flexural strength through a bridge effect of the carbon nanomaterial between micro-cracks with the enhanced cement's matrix. Again, in embodiments, all three coal-derived carbon nanomaterial additives demonstrated better or similar flexural strength enhancement effects compared with that when using commercial graphene oxide.

In embodiments, for flexural strength, all three coal-based carbon nanomaterials can effectively reinforce concrete. In embodiments, all three coal-based carbon nanomaterials, C1, C2, and C3, demonstrate the ability to improve the flexural strength of concrete mixtures that correspond with normal strength (mix 1) and high-strength (mix 2) concrete. In embodiments, the coal-based carbon nanomaterial additives were able to increase the flexural strength of the concrete mixtures by between about 7%, to about 21% compared to that of control sample concrete mixtures without the coal-based carbon nanomaterial additives.

Notably, in an embodiment, the enhanced cement comprising the carbon nanomaterials comprises decreased permeability compared a cement formulation without the coal-derived carbon nanomaterial. In embodiments, the enhanced cement comprises a decrease in permeability of between about 35% to about 86% compared to that of a cement formulation without the coal-derived carbon nanomaterial. In an embodiment, the enhanced cement comprising the carbon nanomaterials demonstrates approximately a one-order of magnitude reduction in permeability, compared to that of a cement formulation without the coal-derived carbon nanomaterial, and also demonstrates change in its porosity with the addition of the carbon nanomaterials. In an embodiment, the carbon nanomaterial provides a similar decrease in permeability to that resulting from using a commercial graphene oxide (GO) additive at similar loading percentages, but at much lower cost. In an embodiment, the reduction in permeability improves cement lifetime by reducing penetration of corrosive chemicals and salts into the cement matrix, such as during downhole drilling and pavement de-icing operations.

Notably, in embodiments, all three coal-derived carbon nanomaterial-enhanced cementitious composite samples demonstrated reduced chloride penetration depths in comparison to a neat cement sample without the coal-derived carbon nanomaterial additives, where the measurement of chloride penetration depth is a good indication of resistance to chemical ingression. In embodiments, the enhanced cement comprises a reduction in chloride penetration depth of between about 40% to about 60% compared to a neat cement sample. As a further comparison with commercially available carbon additives, commercial GO-added cement paste was also tested for chloride ion penetration, and it led to 50% reduction compared to that of a neat cement sample.

Notably, in an embodiment, the amount of the coal-derived carbon nanomaterial mixed with the cement formulation can be tuned to increase the enhanced cement's durability (which is directly related to the enhanced cement's permeability) or the enhanced cement's mechanical strength, namely, the enhanced cement's compressive and flexural strengths. In an embodiment, at a low loading of 0.025% of coal-derived carbon nanomaterials, compressive and flexural strengths can be increased by about >20%, compared to a cement formulation without the coal-derived carbon nanomaterial. In an embodiment, the permeability can be reduced by up to one order of magnitude at a higher loading of about 0.07%. In an embodiment, the loading of coal-derived carbon nanomaterials for optimally increasing an enhanced cement's durability is approximately 5 to 8 times higher than that for optimally increasing an enhanced cement's mechanical strength. In an embodiment, the amount of the coal-derived carbon nanomaterial can be tuned to a low loading to increase the enhanced cement's mechanical strength for applications where the cement is the mail load bearing component, such as in building infrastructure applications. Likewise, in an embodiment, the amount of the coal-derived carbon nanomaterial can be tuned to a higher loading to increase the enhanced cement's permeability for applications that demand durability such as in cement oil well applications where corrosion is a more significant issue than outright mechanical strength.

In some embodiments, the coal-derived carbon nanomaterials are used as a replacement for silica fume additives, which are commonly used as supplementary cementitious materials primarily to improve the mechanical properties and durability of cement.

In some embodiments, the coal-derived carbon nanomaterials are used to reinforce cement mortar, cement concrete, and high performance concrete where larger aggregates and supplementary materials, such as silica fume and fly ash, are added.

In some embodiments, the coal-derived carbon nanomaterials are used to improve wellbore materials in cement oil wells, where harsh chemicals and corrosive gases used subsurface hinder the service life of well casings.

In some embodiments, the coal-derived carbon nanomaterials are added as a chemical admixture agent during cement mixing to simultaneously improve the strength and durability of cement mixture and control the workability, including flow and setting time, at of the cement at a fresh state, or to increase durability of the cement after it hardens. There is currently no such commercial product in the form of chemical admixture that could enable reinforcement to cement materials affecting both mechanical properties and durability.

### Examples

Synthesis of Carbon Nanomaterials from Charred Coal Fines: Charred bituminous Blue Gem coal fines (Knox County, Kentucky, ash content<1.5%) were obtained from Carbon Technology Company (Bristol, Virginia, United States). The charring process was conducted using a mild gasification process where these coal fines were heated at 650-750° C. under an inert atmosphere for 20 minutes. These coal fines used to produce this char are a metallurgical industry waste product because they are too small for use in most furnaces. They are charred to remove value-added liquids and prepare them for briquetting into large pieces which then can be re-used for metallurgical purposes or utilized as a manufacturing feedstock for carbon nanomaterials and composites, such as the ones discussed herein.

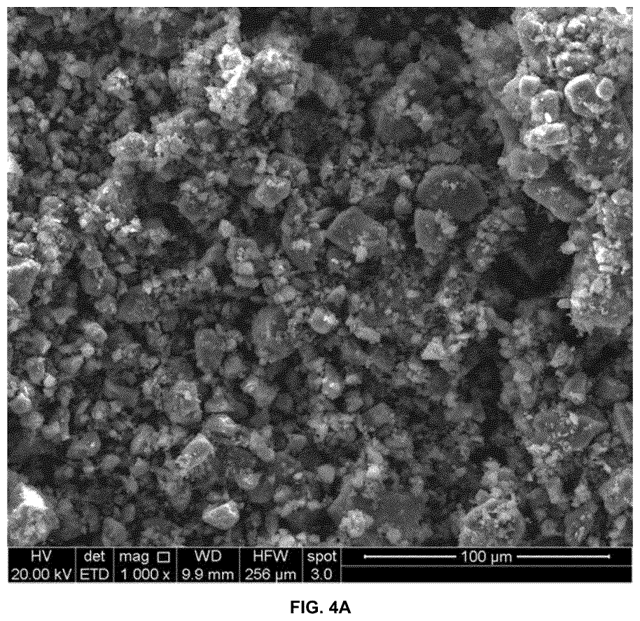

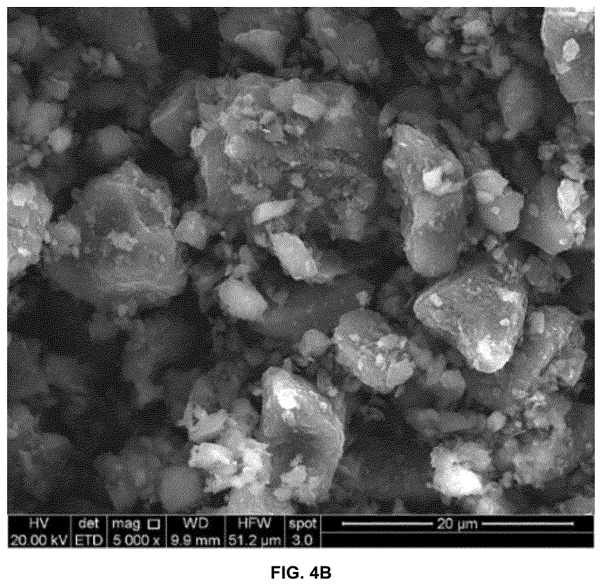

The coal char was used as a feedstock to synthesize carbon nanomaterials by chemical oxidation (C1) and liquid-phase exfoliation (LPE) (C2 and C3). To prepare C1, coal char was first ground using an enclosed shatterbox (SPEXSamplePrep 8530) for 3 minutes to produce a fine powder (5-50 μm and see FIGS. 4A, 4B). Then, 5.0 g of coal char powder was added to a 200 mL mixture of sulfuric acid and nitric acid (3:1 v/v) in a 1-liter flask, and the mixture was refluxed under magnetic stirring at 100° C. for 24 hours. After natural cooling to room temperature, the mixture was diluted with 1800 mL deionized water and subsequently neutralized with sodium hydroxide solution. Finally, the mixture was purified by tangential-flow ultrafiltration (KrosFlo® KR2i TFF system, Repligen) using a 1.0 kilo Dalton hollow fiber filtration membrane at a pressure of 8.0 psi, and concentration mode with a concentration factor of 20 for five times. The production yield of C1 was approximately 20%.

Generally, to synthesize carbon nanomaterials by LPE, raw coal char with or without oxidation was ball-milled into micron-scale coal powders using a ball mill. Then about 5 g of coal powders were exfoliated in about 500 mL of DI water with the addition of cement-friendly surfactant (superplasticizer) using a high-intensity shear mixer for about 2 hours at about 5000 rpm. The surfactant is a conventionally used water-reducing agent in cement industry that is made of a polyethylene glycol copolymer side chain grafted with a polycarboxylate ether copolymer main chain. The commercial products of the water reducing agent are sold by most concrete admixture companies, such as BASF, GCP, Sika, et al. It can help the exfoliation of the carbon nanoflakes and stabilize the suspension from re-agglomeration within cement environment. The proper amount of addition of the surfactant was determined to be about 0.2 wt % to about 1 wt % in aqueous solution. The liquid suspension was finally separated and filtered from large coal particles using cycles of centrifugation at about 1000 rpm.

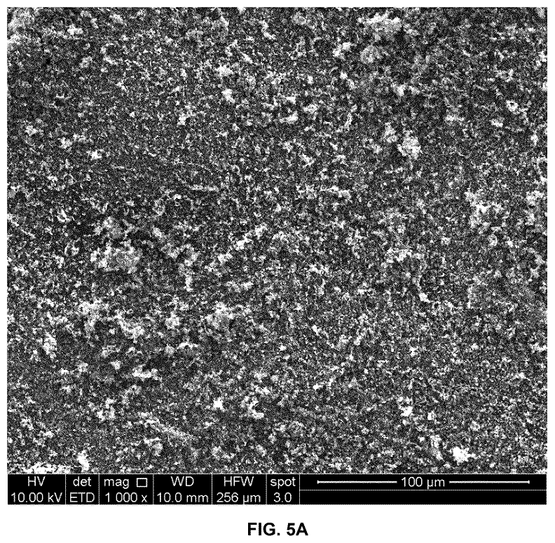

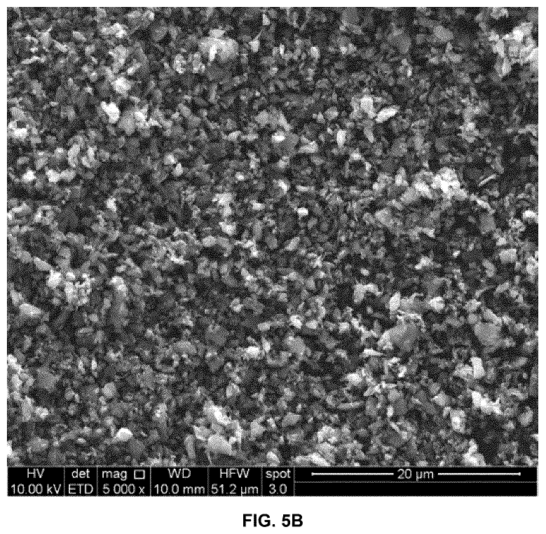

Specifically, for the synthesis of C2, coal char was first ground with the shatterbox for 3 minutes and then wet ball-milled using an attritor (Szegvari Attritor, Union Process) for 2 hours into micron-sized coal char particles (1-5 μm and see FIGS. 5A, 5B). Next, 5.0 g of this ball-milled coal char powder was added into 500 mL of water, along with 5 mL of superplasticizer (SP) from BASF MasterGlenium, which is conventionally used as a water-reducing agent in concrete material. The solution was then high-shear mixed at 5000 rpm using a high-intensity shear mixer (L5MA Laboratory Mixer, Silverson) for 2 hours in an ice bath. The obtained solution was then centrifuged at 1000 rpm for 1 hour. The supernatant was collected as C2 solution, and the concentration was determined. The sediment was also collected and reused as the feedstock for another cycle of LPE.

Specifically, for the synthesis of C3, coal char was first ground with the shatterbox for 3 minutes and then wet ball-milled using an attritor (Szegvari Attritor, Union Process) for 2 hours into micron-sized coal char particles. The ball-milled coal char powder was then chemically oxidized with a mixture of sulfuric and nitric acid at room temperature before LPE. Briefly, 10.0 g of the ball-milled coal char was mixed with 20 mL of sulfuric acid and nitric acid (3:1 v/v) until the coal char was fully wet and the mixture was kept at room temperature for 5 hours. After acid washing by dispersing oxidized coal char in 300 mL DI water, mixing for 10 minutes, and then centrifuging at 5000 rpm for 10 minutes for five times, the obtained oxidized coal char was dried at 120° C. for 3 hours. The LPE was carried out with the oxidized coal char using the same procedure as that for C2. In detail, 5.0 g of oxidized coal char powder was added into 500 mL of water, along with 5 mL of superplasticizer (SP). The solution was high-shear mixed at 5000 rpm for 2 hours in an ice bath. The obtained solution was then centrifuged at 1000 rpm for 1 hour. The supernatant was collected as C3 solution and the concentration was measured. The sediment was used as the feedstock for another cycle of LPE.

Cement Composite Preparation with Three Carbon Nanomaterials at Five Different Dosages: C1, C2, and C3 were incorporated in cement paste and the composite was then characterized. Since SP was added to both C2 and C3 solutions during the synthesis process, the same amount of SP was added to the C1 solution to ensure uniform dispersion of the carbon additives within the cement matrix. Specifically, a solution of coal-based carbon nanomaterials with concentrations of 0.05 to 0.35 wt. % (in aqueous solution) was mixed with dry cement powder without any additional water and mixed and cured for 28 days according to the ASTM 305. The water-to-cement ratio was 0.2. Cylinder samples with the dimension of 1-in. diameter×2-in. length were prepared for the compression test, porosity/permeability test, and chloride penetration test with the dosages of each carbon nanomaterial in the range of 0.01% to 0.07% (to cement weight). Prism samples with a dimension of 0.8 in.×0.8 in.×3.2 in. were also prepared for the three-point bending test. The permeability/porosity tests and chloride penetration tests were performed with the same set of samples as those used for the compression test. Commercial graphene oxide (GO) from Graphenea, Inc. was also used as an additive to prepare cement paste samples at the dosage of 0.025 wt. % and 0.05 wt. % for performance comparison with coal-derived additives. Concrete samples with two different mix designs were prepared in cylinders and prisms with the mix ratio shown in Table 4. Mix 1 only contains water, sand and coarse aggregate, which simulates a normal-strength concrete with the compressive strength less than 6000 psi. Mix 2 has a lower water to cement ratio at 0.32, and is absent of coarse aggregate. 5 wt. % of silica fume is added to improve the compressive strength, and it simulates a high-strength concrete with the compressive strength more than 6000 psi. The three carbon nanomaterials were added at the dosage of 0.02 wt. %, 0.04 wt. %, and 0.06 wt. %. Concrete prism samples are in the dimension of 1.57 in.×1.57 in.×6.3 in., and concrete cylinder samples are in the dimension of 2.5 in.×5 in.

TABLE 4
Mix Design for Concrete Samples (weight ratio to cement)

| | Mix 1 | Mix 2 |
|---|---|---|
| Water to cement | 0.4 | 0.32 |
| Sand to cement | 1.6 | 1 |
| Coarse aggregate | 2.1 | |
| to cement | | |
| Fly ash to cement | | 0.2 |
| Silica fume to | | 0.05 |
| cement | | |

Characterization and Measurements: XRD measurements were carried out using a PANalytical X'pert pro X-ray diffractometer (XRD) with Cu Kα radiation (λ=1.5418 Å) with a step size of 0.017° and 200 s/step in the 2θ range from 10° to 70°. The XRD was operated at 45 kV and 40 mA. X-ray Photoelectron spectra (XPS) of the materials were obtained with a PHI 5600ci spectrometer equipped with a hemispherical electron analyzer and a monochromatic Al Kα (1486.6 eV) radiation source. The pass energy of the analyzer was 55 eV. Scanning electron micrographs and energy dispersive X-ray spectra (SEM/EDS) were acquired with a FEI Quanta 600F microscope operated at 10-20 kV. TEM images were taken using a JEOL JEM2100F operated at an accelerating voltage of 200 kV.

For mechanical property testing of cementitious composites, compression tests were performed on cylinder samples according to ASTM C39. Three-point bending tests were performed on prism samples according to ASTM C348. At least three samples were tested for each batch and the average values were taken as the strength of the cement composites.

For porosity and permeability testing, cylinder samples were dried in a desiccator until the mass of samples stabilized. The porosity was tested using a TEMCO Helium Porosimeter HP-401. After porosity tests, each cylinder sample was tested for permeability in a TEMCO Pulse-Decay Permeameter, which sets a pore pressure throughout the sample, sends a differential pulse through the entire sample, and measures travel time to calculate permeability.

The modified chloride penetration test was conducted on cement cylinders according to AASHTO T259, where the top face of the sample was exposed to 3% sodium chloride solution, and the bottom face was exposed to 50% relative humidity of air. After exposure for 30 days, the sample was split into halves vertically, and the split surface was sprayed with silver nitrate. The chloride ion's penetrated depth was measured for each sample, and the average value was taken from each batch.

The microstructure of the cement composites was analyzed using differential scanning calorimetry (DSC), thermogravimetry analysis (TGA), and XRD. The simultaneous DSC-TGA measurements were conducted using a Mettler Toledo TGA/DSC 3+. The tests were performed from 35° C. to 1000° C. with a ramp rate of 10° C./min under the environment of nitrogen gas. TGA was also utilized to examine the mineral matter content of the coal char under the environment of air gas. The XRD pattern was measured with the cement samples using the same condition mentioned above

Another type of carbon nanomaterial is processed from coal char for cement application are carbon dots. The coal char is firstly ground using a shatterbox for about 3 mins to produce a fine powder. Then, about 2.5 g ground coal char was added in a mixture of H₂SO₄ and HNO₃ in a 1-L flask and refluxed under magnetic stirring at about 100° C. for about 24 hours. After natural cooling to room temperature, the product mixture was diluted by slowly pouring the solution into about 1800 mL DI water and was subsequently neutralized by slowly adding about 100 g of NaOH. Finally, the carbon dots solution was purified by cross-flow ultrafiltration with about 1.0 kilo Dalton filtration membrane at about 8.0 psi using concentration mode with a concentration factor of about 20 for 5 times.

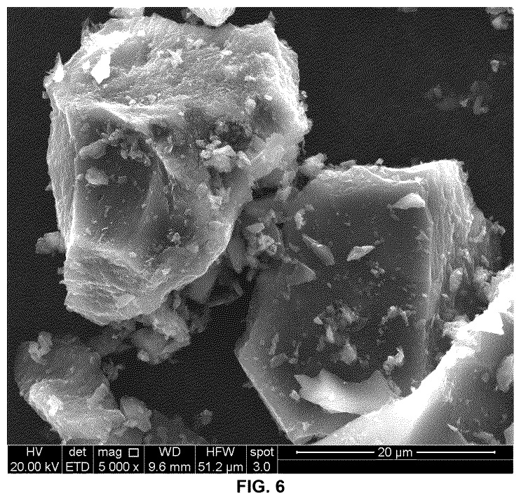

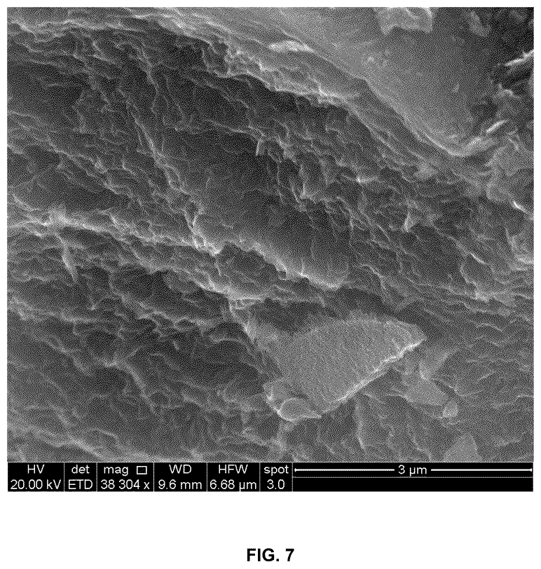

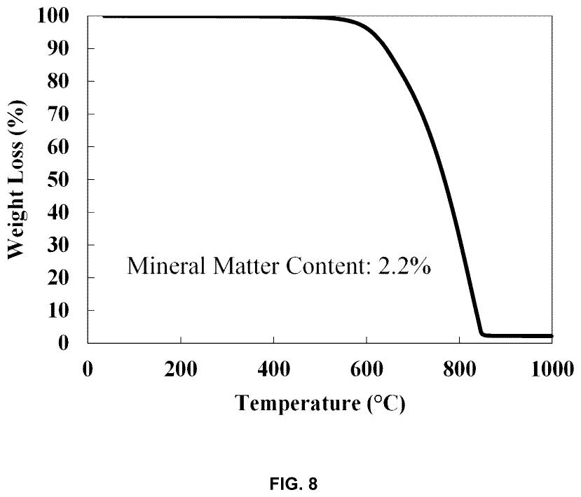

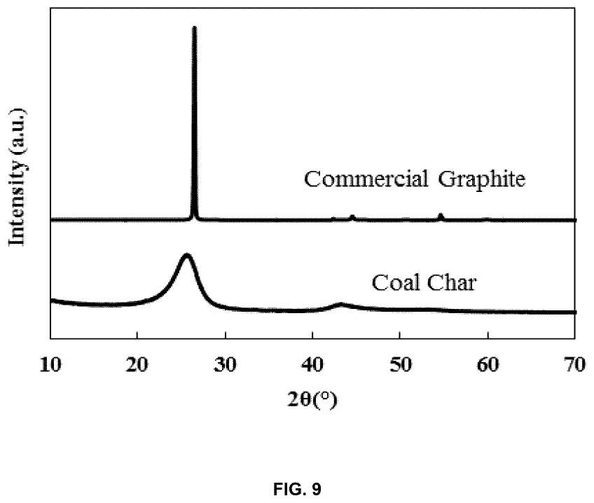

Characterization of Coal Char Feedstock: The composition of coal char was analyzed by SEM/EDS, which revealed carbon is the primary element (93.6 at. %) and oxygen is the second most abundant element (5.0 at. %), whereas other elements such as Al, S, Si, and Fe are also found at concentrations less than 1.0 at. % (Table 5). The morphology of the coal char characterized by SEM in FIGS. 6, 7 displays the layered structure formed from stacking micron-sized crumpled carbon sheets. The ash content of coal char was analyzed with TGA in air, which gives 2.2% as seen in FIG. 8. The XRD pattern of coal char in FIG. 9 exhibits a broad, but intense, 002 peak centered at 25.8°, suggesting the high degree of order of stacked carbon layers, similar to the layered structure in graphite, but at a larger d spacing. The highly ordered, layered structure of Blue Gem coal char makes it an appropriate feedstock candidate to produce carbon nanomaterials by a mechanical exfoliation processes.

TABLE 5
Composition of Blue Gem Coal Char Measured by EDS Analysis.

| | Percentage |
|---|---|
| Element | (atomic %) |
| C | 93.6% |
| O | 5.0% |
| Al | 0.9% |
| S | 0.2% |
| Si | 0.2% |
| Fe | 0.1% |

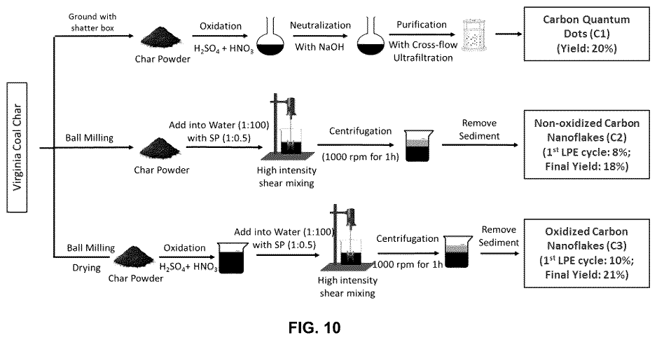

Synthesis of Carbon Nanomaterials from Coal Char: The synthesis procedures of C1, C2, and C3 are schematically illustrated in FIG. 10, in which C1 was synthesized by chemical oxidation using a mixture of concentrated sulfuric and nitric acids, whereas C2 and C3 were synthesized by LPE. The coals and coal char are well known to contain nanometer-sized crystalline graphitic carbon domains with defects that are linked by aliphatic amorphous carbons.

During the production of C1 samples, heating the coal char in concentrated sulfuric and nitric acids initiates exfoliation of the nanometer-sized crystalline graphitic domains into small single sheets of graphenic carbon. The acid treatment also oxidizes most of the aliphatic carbon attached to these domains into CO₂ and partially oxidizes the edges of the exfoliated graphenic sheets to form hydroxyl and/or carboxyl functional groups. The total diameter of the sheets is usually 2-4 nanometers. The C1 samples are referred to as carbon quantum dots, also called graphene quantum dots. After acid oxidation, neutralization, and purification steps were carried out to remove excess acids and byproducts. The obtained C1 has a production yield of approximately 20 wt. %.

For the synthesis of C2 and C3, we take advantage of the layered structure of the coal char feedstock and use an LPE method to exfoliate the coal char into carbon nanoflakes. The wet ball-milling step reduces the size of the coal char particles down to a few microns (1.0-5.0 μm) to facilitate the exfoliation of coal char in the subsequent high-shear exfoliation step. For C2, the ball-milled coal char was mixed with SP solution before liquid-phase high-shear exfoliation, which allows SP to adsorb on the surface of exfoliated carbon nanoflakes, stabilizing them in water, as well as in the cement pore solution later, and prevents them from restacking after exfoliation. The LPE of coal char was achieved by high-shear mixing at a speed (5000 rpm) at which coal char particles were trapped in the narrow space between the rotor blade and stator of the mixer head, and the shear forces developed in the liquid separated the carbon layers of coal char particles. After that, centrifugation at low 1000 rpm was applied to separate the freshly exfoliated carbon nanoflakes and unexfoliated coal char particles. Subsequently, the supernatant containing fresh-exfoliated carbon nanoflakes was collected. The obtained C2 solution was highly stable, not only in water, but also in the cement pore solution, for at least 90 days, requiring only a mild bath-sonication for 10 minutes before use. This ensures the good dispersibility of C2 in the cement matrix during the curing process. The exfoliation yield of C2 was 8%, which is significantly higher than the LPE of graphite which is only about 0.2%. Moreover, unexfoliated coal char collected from the centrifugation step was reused as the feedstock for another cycle of LPE, with a slightly reduced exfoliation yield of 6% for the second cycle. The total exfoliation yield after 3 LPE cycles reached up to 18%.

Similar to C2, C3 was also prepared by LPE. However, an additional step of mild chemical oxidation of ball-milled coal char with a mixture of sulfuric and nitric acid at room temperature was carried out prior to high-intensity shear mixing. This was to introduce oxygen functional groups on the surface and edge of carbon nanoflakes and improve dispersibility in water. The exfoliation yields of C3 were 10%, 7%, and 4% for the first, second, and third LPE run, respectively. The total exfoliation yield after three LPE cycles reached up to 21%, which was slightly higher than observed for C2 samples.

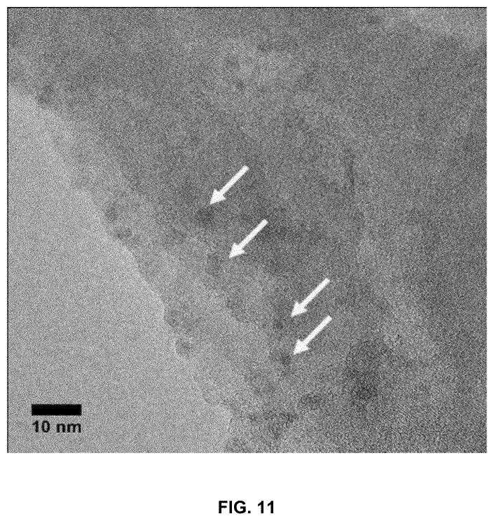

Characterization of Carbon Nanomaterials: The three carbon nanomaterials were characterized by SEM, TEM, and XPS. Based on the TEM results (FIG. 11), C1 consisted of small carbon quantum dots that are 2-4 nm in lateral size and only a single carbon layer in thickness. It was heavily covered with oxygen groups, as indicated by the low C/O ratio measured by XPS (Table 3).

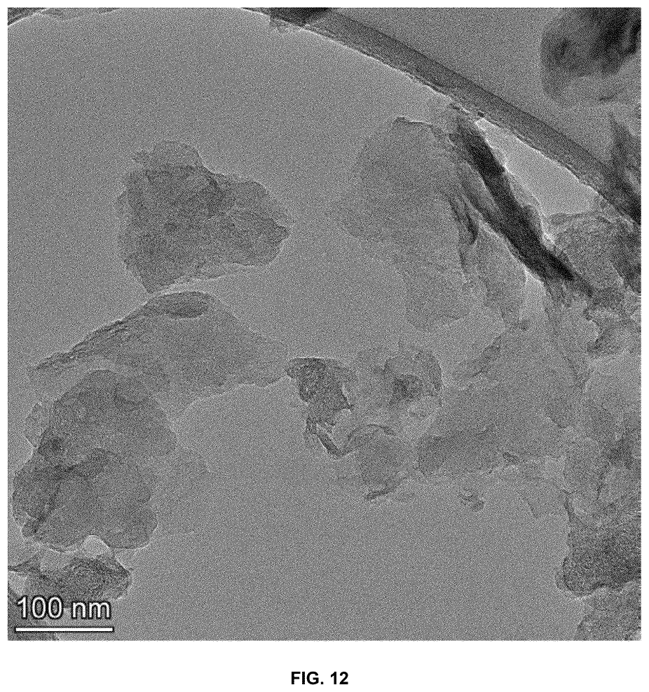

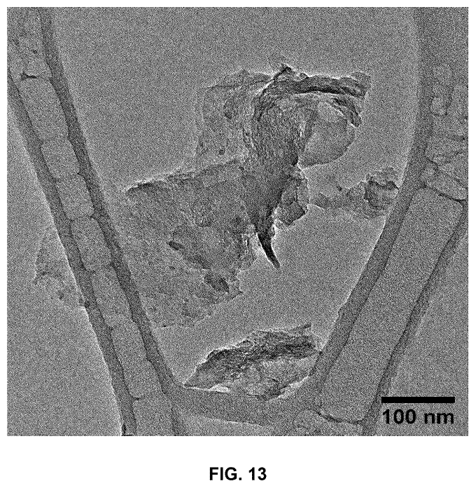

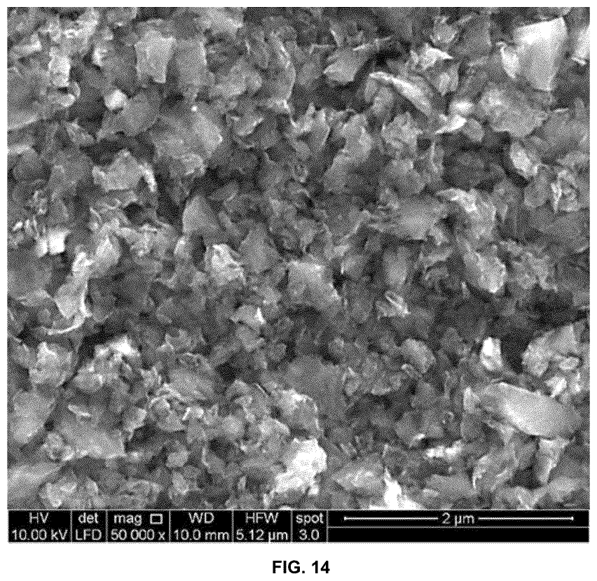

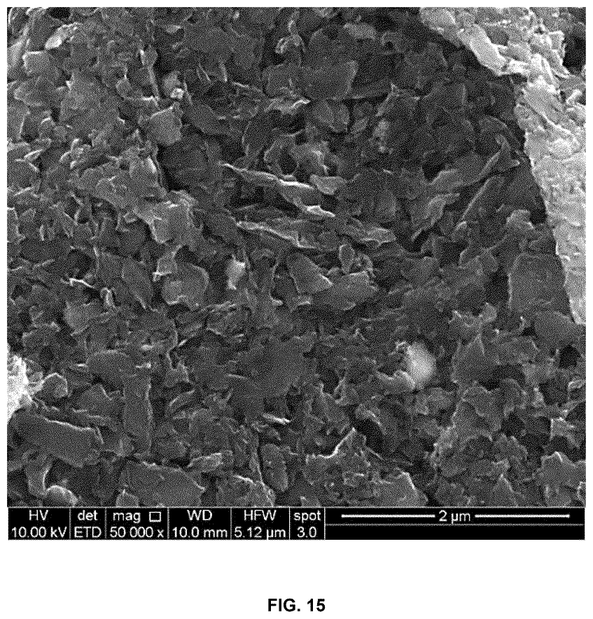

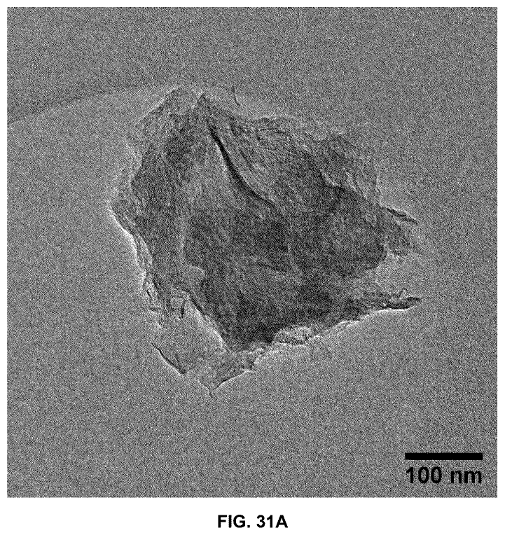

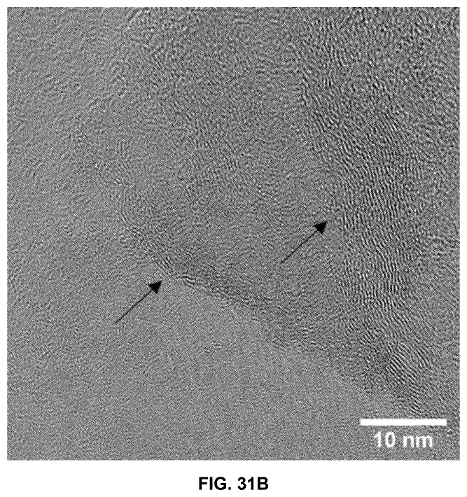

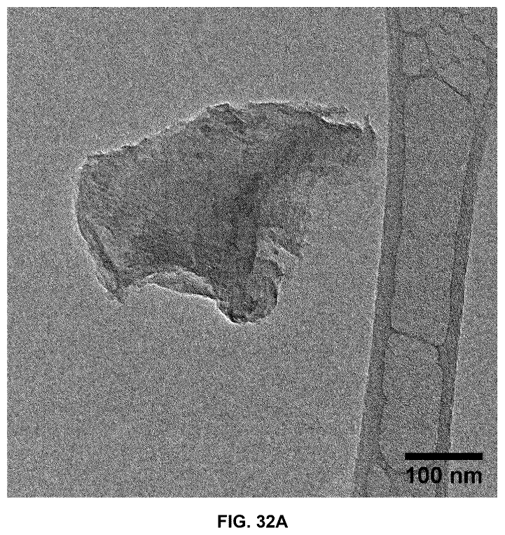

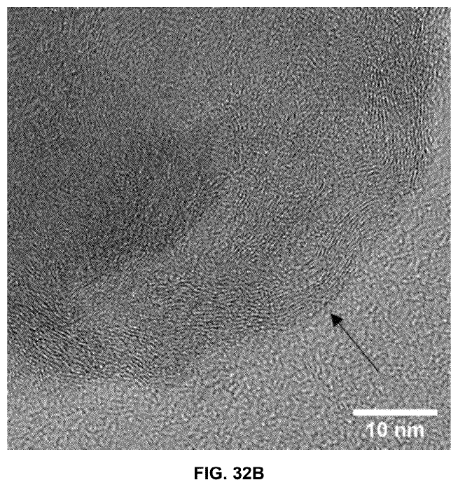

In contrast, C2 (FIGS. 12, 31A, 31B) and C3 (FIGS. 13, 32A, 32B) produced using the LPE method are 2D nanoplatelets. The coal-based carbon nanomaterials produced from this process are categorized into two groups: non-oxidized carbon nanoflakes (C2) and oxidized carbon nanoflakes (C3). Based on the SEM images (FIGS. 14, 15) and quantitative TEM image (FIGS. 12, 13, respectively) analysis of C2 and C3, respectively (Table 1), their lateral sizes and thicknesses were in the range of hundreds of nm and <10 layers, respectively (Table 3). The aspect ratio is calculated by dividing the lateral size by the thickness, assuming each carbon layer has about 1 nm thickness. The C/O ratio in Table 3 was calculated based on XPS analysis. C2 (FIGS. 31A, 31B) and C3 (FIGS. 32A, 32B) exhibited the 2D nanoplatelet morphology, with graphitic and amorphous layers observed under high-resolution TEM. They both have a median lateral size of about 70-500 nm (Table 1) and 3-7 stacked carbon layers. The largest difference between C2 and C3 samples was that the surface of the C3 was moderately oxidized, resulting in a lower C/O ratio than C2 (Table 3). The purpose of the addition of oxygen groups on C3 was to examine how functional groups affect their reinforcing effects within the cement matrix. The lateral size and thickness of C2 and C3 are comparable with some of the graphene nanoflakes produced using LPE from graphite, which illustrates that using coal char can produce carbon nanoflakes at a much higher yield and with similar morphology to those synthesized from graphite.

The Application of Coal-based Carbon Nanomaterials in Cement Paste: Mechanical Properties: The general physical morphology of the three types of carbon nanomaterials synthesized from coal was investigated. C2 and C3 resemble the properties of graphene nanoflakes reported in the literature for the enhancement of cementitious composites, whereas the much smaller nm-sized C1 has not been reported in the literature for this application, to the best of our knowledge.

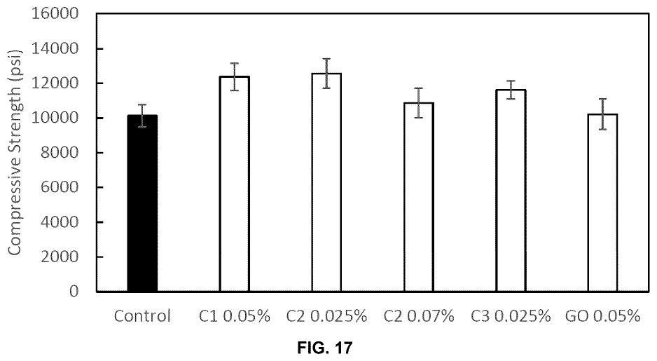

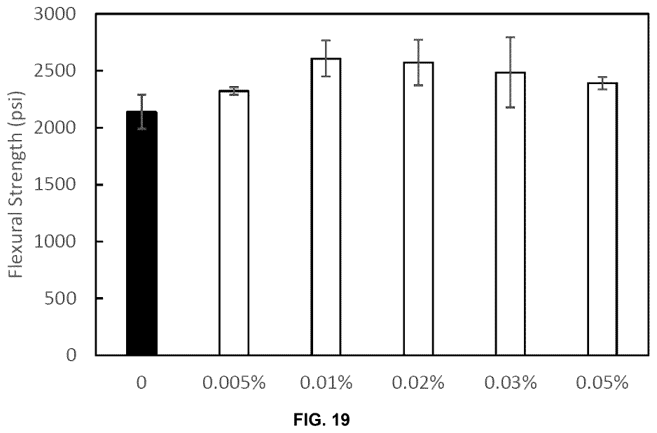

Cement Property Evaluation: The coal-based carbon nanomaterial solution was added into the cement powder without adding extra water, and mixed and cured according to the ASTM standard for the preparation of cement paste. Compression test was performed on cylinder samples of cement paste that had carbon nanomaterials added to the formulation. The samples were: neat paste (control), carbon dots (C1), non-oxidized carbon nanoflakes (C2), oxidized carbon nanoflakes (C3) and commercial graphene oxide (GO). Each nanomaterial additive was evaluated at several different weight percentages varying from about 0.01 to about 0.07% and optimum performance for each carbon nanomaterial is reported in FIG. 17. The 3-point bending test was conducted with each nanomaterial additive, and the test was also conducted on C2 added to cement paste at 5 different dosages (FIG. 19). The permeability and porosity tests were performed and measured with a constant flow nitrogen permeameter and a helium porosimeter.

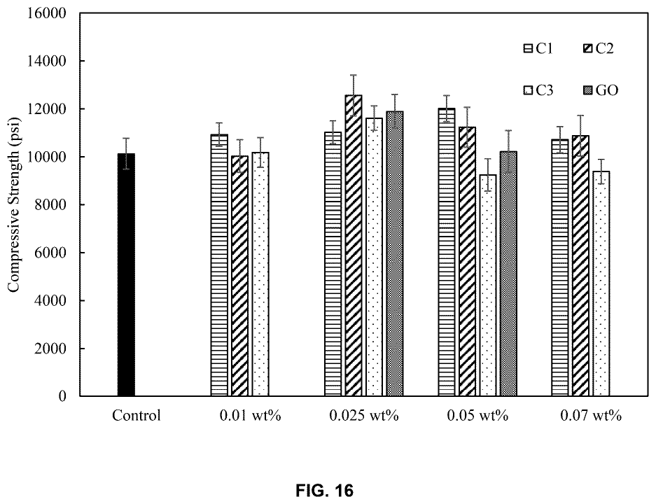

Compressive Strength: All three coal-based carbon nanomaterials demonstrate the ability to improve the compressive strength of the cement paste (FIG. 16). The optimum loading for the carbon quantum dots (C1) was 0.05 wt. %, enabling an improvement of 19% in compressive strength compared to the neat cement used as a control sample. The non-oxidized carbon nanoflakes (C2) performed best at a loading of 0.025 wt. % which imparts a 24% improvement over the control sample. The oxidized carbon nanoflakes (C3) have an optimum dosage at 0.025 wt. %, leading to an improvement of 15% in compressive strength. The highest improvement seen for the compressive strength of the commercial GO samples was 17% which occurs at the loading of 0.025 wt. %. Higher loadings (C1 at 0.07 wt. %, C2 at 0.07 wt. %, and C3 at 0.05 wt. % and 0.07 wt. %) tend to result in a decreased enhancement effect, which is likely due to the challenge associated with maintaining good dispersion. Among the three carbon nanomaterials, C2 shows the largest reinforcing effect on compressive strength, and all three coal-derived carbon nanomaterials have better or comparable improvements compared to the commercial GO, as shown in FIG. 16. The improvement of compressive strength from the carbon additives could be due to a nano filler effect, which densifies the microstructure of cement composites. Generally, all three carbon nanomaterials outperform the commercial graphene oxide, which is applied at the similar dosage to improve the compressive strength.

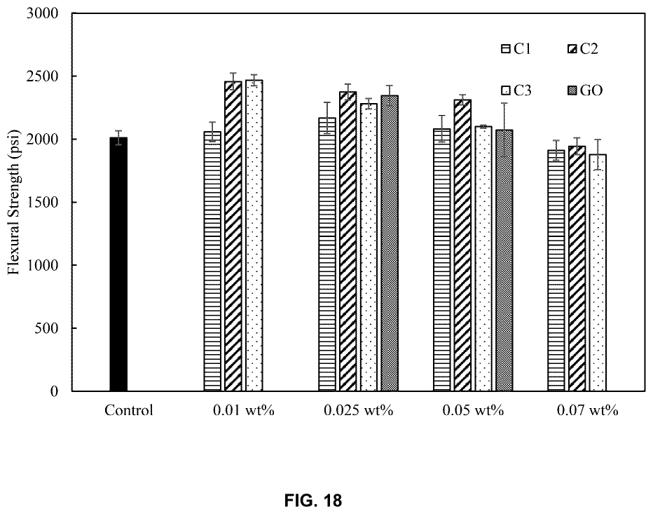

Flexural Strength: All three carbon nanomaterial additives were added to cement at different dosages and measured for their flexural strength under a three-point bending test (FIG. 18). The largest improvement of flexural strength of approximately 23% was observed with C2 and C3, both at 0.01 wt. %, compared to the control sample. The improvement in flexural strength with C2 and C3 decreased with increasing dosages. In contrast, the optimum dosage for C1 was at 0.025 wt. %, leading to an improvement of flexural strength by approximately 8%, which was more modest compared to C2 or C3. Again, all three coal-derived carbon additives demonstrated better or similar enhancement effects compared with commercial GO in our experiments. The enhancement of flexural strength might be due to the bridge effect of the carbon nanomaterial additives between micro-cracks within the cement matrix.

The literature reported that adding graphite-derived graphene materials (including GNP or GO) imparts improvement to the compressive and flexural strength of cement composites. The typical improvement of compressive and flexural strength reported was in the range of about 10-40% and about 10-60%, respectively. These reported values are comparable to the enhancement caused by our coal-based carbon additives. Given the fact that coal feedstocks are much more abundant and economical, and that the production yield is much higher, coal-derived carbon nanomaterials have obvious advantages over graphite based carbon additives for cement composite applications.

Durability: In addition to mechanical properties, improving the durability of cementitious materials can also have a significant impact by ensuring structural integrity and reducing environmental footprint. The durability of concrete governs the service life of concrete structures and thus has a significant impact on the life-cycle cost. The durability can be increased by reducing the ingression of both liquids and gases into concrete, and it highly depends on the permeability and porosity of the cement matrix. Studies have found that the graphene family of materials can refine the pore structure, increase the durability of cement-based composites, and extend the lifetime of the concrete structure.

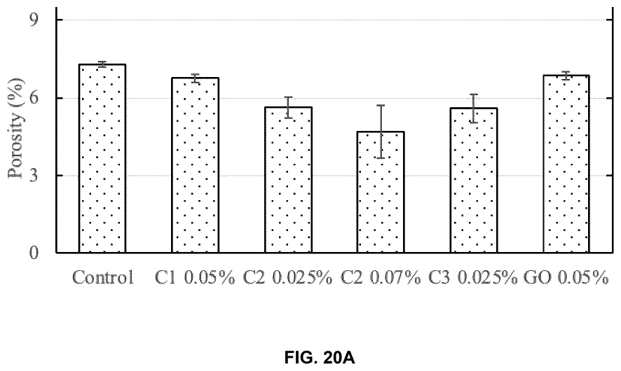

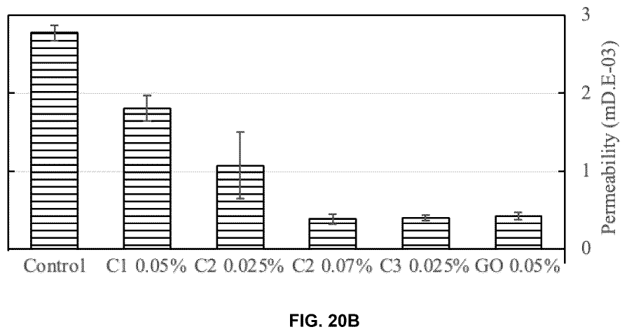

Permeability and Porosity: FIGS. 20A and 20B show the effect of coal-based additives on the permeability and porosity of cement. Each of the C1, C2, and C3, as well as the commercial GO, additives reduced the permeability of the cementitious composite. C2, at 0.07 wt. %, and C3, at 0.025 wt. %, demonstrated the largest reduction in permeability by approximately 86%. The porosity of the cement composites was not as dramatically impacted, but C1 at 0.05 wt. %, C2 at 0.025 wt. %, and C2 at 0.07 wt. %, still led to a pronounced reduction in porosity by 8%, 23%, and 36%, respectively. The addition of nanomaterials likely had a significant impact on the nano-sized pores, but a limited impact on the micro-scaled pores. Therefore, the total porosity was expected to be only partially reduced as a result of the reduction of nano-pores, which agrees with the observed test results (FIGS. 20A, 20B). The reduction of permeability should improve material lifetime by reducing penetration of corrosive chemicals and salts into the cement matrix during downhole drilling and pavement de-icing operations. The commercial graphene oxide (GO), compared to the coal-based carbon nanomaterials, shows a similar reduction on permeability/porosity but at a much higher cost. This illustrates the advantage of the coal-derived carbon nanomaterial additives over commercially available graphene oxide.

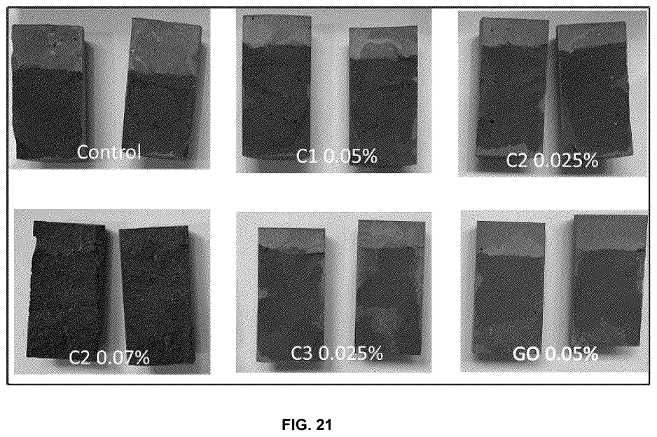

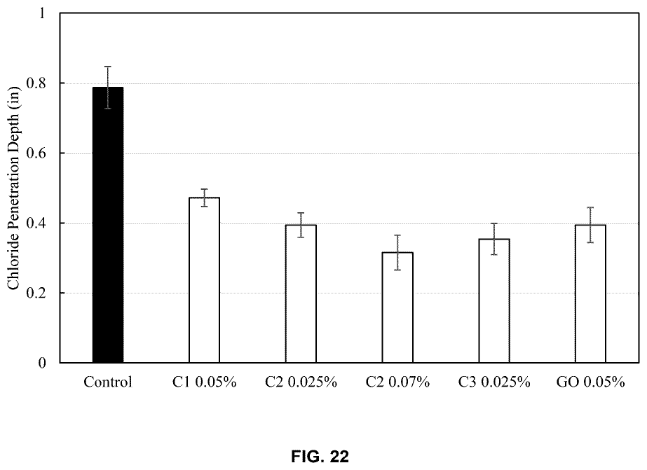

Chloride ion penetration measurements: The effectiveness of carbon additives for improving the anti-corrosion and durability properties of cementitious composites were further evaluated with chloride ion penetration measurements. The measurement of chloride penetration depth is a good indication of the resistance to chemical ingression. All three nanomaterial-enhanced samples have reduced chloride penetration depths in comparison to the neat cement sample (FIGS. 21, 22). C2 at 0.07 wt. % enabled the largest reduction in chloride ion penetration by 60%. C1 at 0.05 wt. % results in 40% reduction and C3 at 0.025 wt. % exhibited 55% reduction in chloride penetration depths. As a further comparison with commercially available carbon additives, commercial GO-added cement paste was also tested for chloride ion penetration and it led to 50% reduction. It is evident that the coal-based carbon nanomaterials studied here demonstrate comparable, or even superior, capabilities for reducing cement's porosity and permeability compared to those reported in the literature using graphite-derived additives. This work confirms that improved effectiveness in delaying the ingression of water or corrosive chemicals can be achieved using carbon additives synthesized from inexpensive coal feedstocks.

Optimizing Mechanical and Durability Properties: We have shown that adding coal-derived carbon additives can enhance the mechanical properties and the durability of cement by improving the compressive strength, flexural strength and reducing the permeability. At a low loading of about 0.025% of coal-derived carbon additives, the compressive and flexural strength can be increased by about >20% while the permeability can be reduced by up to about one order of magnitude at a higher loading of about 0.07%. This observation is consistent with previous reports that the mechanical properties are usually optimized at low carbon additive loadings, whereas the durability of cement (directly related to permeability) can be further improved at much higher loadings. The reason is that the mechanical properties are more sensitive to the dispersion of the additives within the cement matrix as well as the workability of the composite materials. High loadings of nano-additive lead to more difficulty in uniform dispersion and tend to cause deteriorated workability of the composite material due to the large amount of the dispersing agent (superplasticizer in this invention) required at higher loadings. On the other hand, permeability/porosity and the chloride penetration are less sensitive to the dispersion condition of the nanomaterials and demonstrates better performance with higher loadings. The optimum loading for enhancing cement durability is normally about 5 to about 8 times higher than that for the enhancement of mechanical properties, which is also observed in our studies. Therefore, at low carbon additive loadings, the mechanical properties of the cement composite can be optimized for applications such as building infrastructure where cement concrete is the main load bearing component. On the other hand, permeability can be further enhanced at higher carbon additive loadings for applications that demand durability, such as cement oil wells, where corrosion is a more serious issue than mechanical strength.

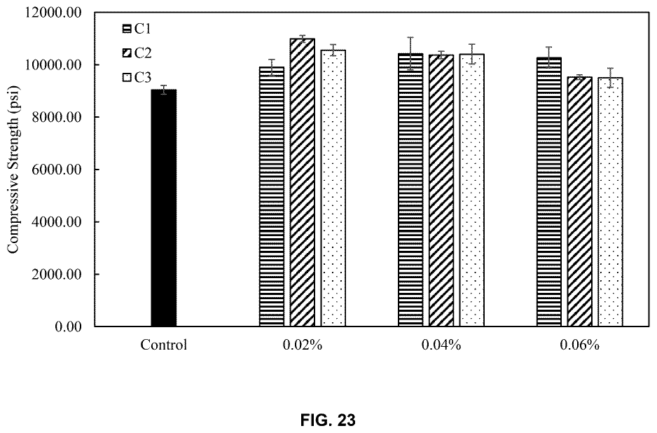

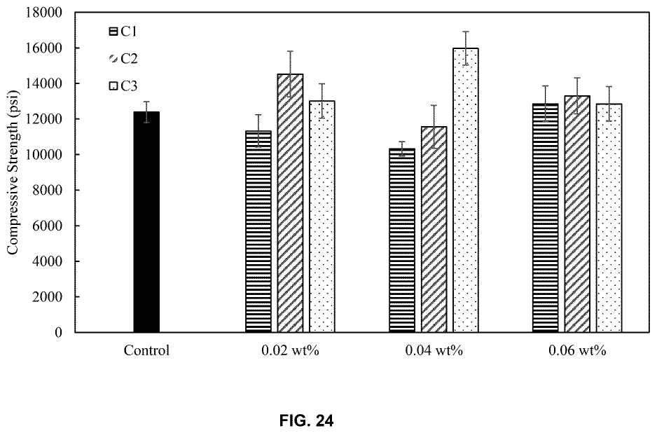

Coal-derived Carbon Nanomaterials as Additives for Concrete: The effect of coal-based carbon additives on the mechanical properties of concrete was also studied. Two mix designs that correspond to normal strength and high-strength concrete were prepared, as described in Table 4. For mix 1, all three carbon nanoadditives were able to improve the compressive strength at varying degrees (FIG. 23). The largest improvement of C1, C2, and C3 were 15%, 21%, and 17%, respectively. The optimum additive dosage for C2 and C3 occur at 0.02 wt. %, and the optimum dosage for C1 at 0.04 wt. %. For mix 2, C1 showed a 4% increase in compressive strength at the optimum loading of 0.06 wt. %. C2 showed a 17% increase in compressive strength at 0.02 wt. %. (FIG. 24). C3 had the largest reinforcing effect of 29% increase in compressive strength at a loading of 0.04 wt. % compared to the control sample used for mix 2 concrete materials. The oxidized carbon nanoplatelet additives (C3) might have a better dispersion in mix 2 concrete compared to mix 1 concrete due to the introduction of silica fume, which was expected to consume some amount of the calcium hydroxide in the cement pores and reduce the cross-linking effect. At higher dosages, all samples have little effect on compressive strength, which was consistent with the observation in cement paste samples (FIG. 16).

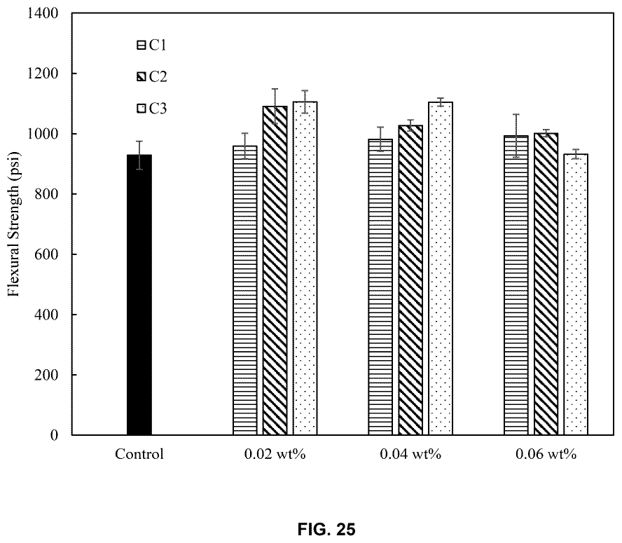

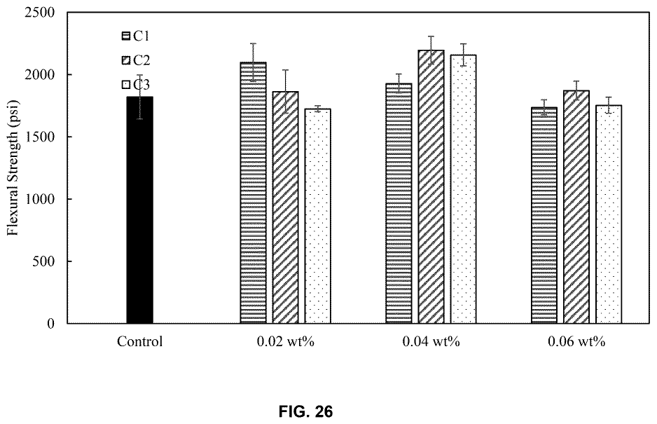

For flexural strength, all three coal-based carbon nanomaterials can effectively reinforce the concrete. For mix 1, the largest improvement of C1, C2, and C3 were 7%, 17%, and 19%, respectively (FIG. 25). For mix 2, the largest improvement of C1, C2, and C3 were 15%, 21%, and 18%, respectively (FIG. 26). C1 has less reinforcing effect on flexural strength compared to C2 and C3 for both mixes, while both C2 and C3 demonstrate promising reinforcement effect on both compressive and flexural strength of concrete.

Characterization of Hydration Products: Fundamentally, the mechanical properties of cement composites are directly related to the microstructure and composition of cement hydrates, in particular, calcium silicate hydrate, C—S—H, and Portlandite, Ca(OH)₂. The amorphous C—S—H is considered as the strongest phase in hardened cement paste, and Ca(OH)₂ is considerably weaker. In this research, the proposed reinforcement mechanisms are: 1) the nanoadditives refine the nanostructure of the hydration products, which leads to enhancement of the mechanical properties; 2) the large specific surface area of the carbon nanomaterials (especially C2 and C3) make them act as the nucleation site, which could facilitate the hydration reactions and lead to improved mechanical properties; and 3) the microstructure is refined with the addition of nanomaterials, where the nanoadditives fill the pores leading to a denser microstructure with lower total porosity. The total porosity has been examined in the permeability/porosity test in the previous section and proves the densification effect with the addition of carbon nanomaterials. In order to further understand the mechanism of property reinforcement of cement composites, characterization of hydration products was carried out using XRD and DSC-TGA.

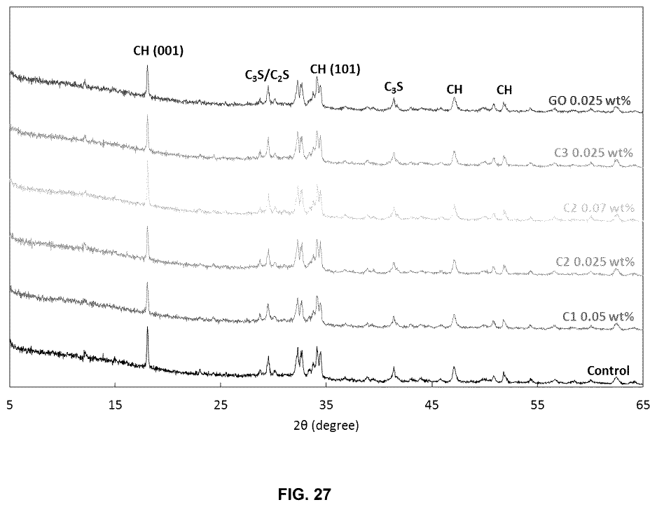

The XRD patterns of the cement samples at the age of 28 days are presented in FIG. 27. Typical cement hydration products such as ettringite, Portlandite, tricalcium silicate (CS), dicalcium silicate (C₂S) were detected for all samples, and the addition of carbon nanoadditives neither added nor eliminated any specific hydration products. The amorphous C—S—H was not detectable with XRD. On the other hand, the crystal orientation of Portlandite (i.e., crystalline calcium hydroxide) changed with the incorporation of carbon additives, which was directly correlated with the strength of cement-based materials: more random crystal orientation led to higher strength. The crystal orientation can be estimated by the orientation index value of CH crystals, R with the following equation;

$$R = 1.35 \times {I}_{001} / {I}_{101} \qquad ( 1 )$$

where R is defined as 1.35 times the ratio of the peak intensities at 001 (at 18.0°) and 101 (at 34.1°) of XRD pattern for CuKα radiation. The R values for different cement samples are listed in Table 6. When the CH crystals are randomly oriented, R=1; when the arrangement of CH crystals are aligned, R>1; and the larger R is, the more aligned the crystal orientation is.

In this work, the R values were reduced for C1, C2, and C3, indicating that the carbon nanomaterial additives led to a more random orientation of the CH crystals, thus preventing the growth of the CH crystals. Not surprisingly, the reduction in R (Table 6) followed a similar trend to the compression test results (FIG. 16): C2 at 0.025 wt. % with the largest increase in compressive strength had the largest decrease of R, C1 at 0.05 wt. % and C3 at 0.025 wt. % had smaller yet still obvious decrease of R corresponding to smaller and measurable increase in compressive strength, and C2 at 0.07 wt. % had the least decrease of R and also the smallest enhancement in compressive strength compared to the neat control sample without any carbon additives. The commercial GO also had a reduced R value compared to the control sample.

TABLE 6
Crystal Index R of Portlandite of Cement Paste Samples
with Different Coal-derived Carbon Additives, Commercial
GO Additive and the Neat Control Sample

| | | C1 | C2 | C2 | C3 | GO |
|---|---|---|---|---|---|---|
| | | 0.05 | 0.025 | 0.07 | 0.025 | 0.025 |
| | Control | wt. % | wt. % | wt. % | wt. % | wt. % |
| Orientation Index | 2.30 | 1.84 | 1.81 | 2.18 | 1.89 | 1.74 |
| of CH Crystal, R | | | | | | |

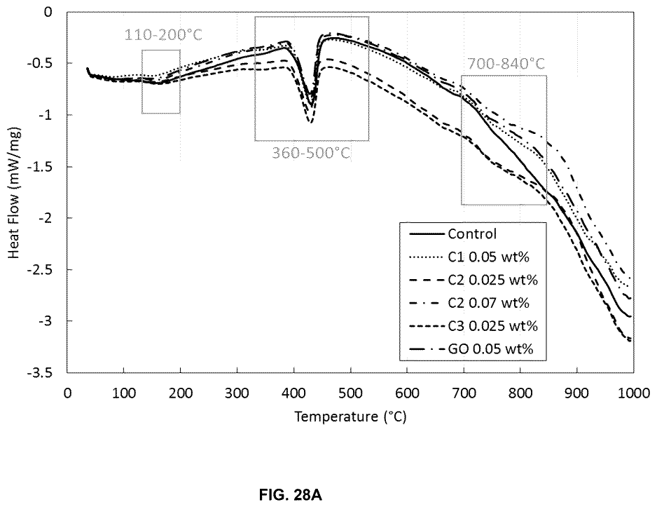

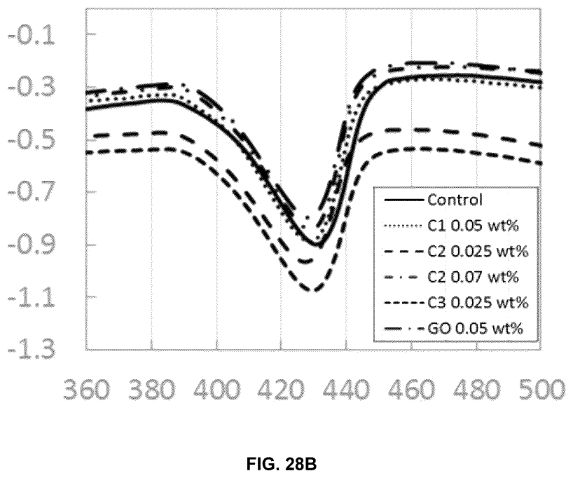

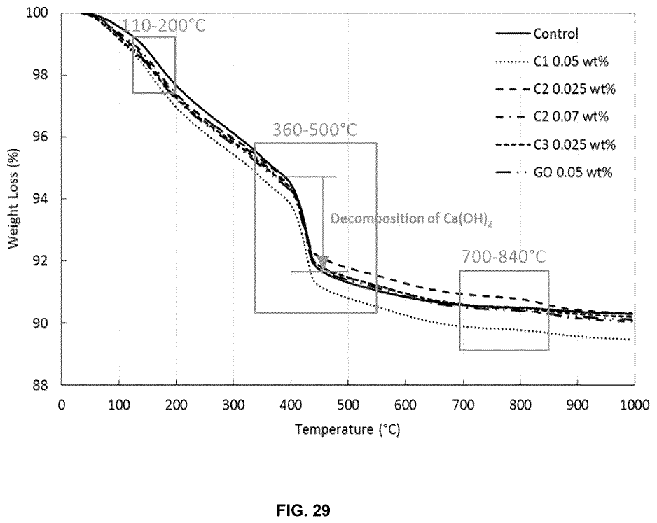

A simultaneous DSC-TGA measurement was conducted on cement samples at the age of 28 days. DSC measures the difference in heat (energy) needed to keep both the reference material and the sample at the same temperature. It is used to study the occurrence of glass transition, crystallization, oxidation, and chemical reactions. TGA measures the change of mass in terms of temperature while the sample is subjected to a controlled temperature. The heat flow (in mW/mg) and weight loss (in %) obtained for the cement paste samples at a given temperature are shown in FIGS. 28A, 28B, and 29. In FIG. 28A three significant endothermic heat flow peaks can be observed. The first peak in the temperature range from 110° C. to 200° C. corresponds to the dehydration reactions caused by the loss of water mainly from calcium silicate hydrates. The reactions in this temperature range are associated with a subtle weight loss of ˜3% (see FIG. 29 for detail). The second peak in the temperature range from 390° C. to 450° C. represents the decomposition of Portlandite (see FIG. 28B and it is accompanied by a significant weight loss of 7% (see FIG. 29). The peaks in the temperature range 700° C.-840° C. correspond to the decomposition of calcite (CaCO₃), which is associated with a very minimal weight loss as shown in FIG. 29. The Ca(OH)₂, CaCO₃, and C—S—H contents were calculated by the following equations:

$$LOI ( CH ) = {Ca ( OH )}_{2} mass loss from 390 - 450 ° C . / samples mass at 1000 ° C . \times 100 \qquad ( 2 )$$

$$LOI ( CC ) = {CaCO}_{3} mass loss from 700 - 840 ° C . / samples mass at 1000 ° C . \times 100 \qquad ( 3 )$$

$$LOI ( CSH ) ( \% ) = mass loss from 105 - 1000 ° C . / sample mass at 1000 ° C . \times 100 - LOI ( CH ) - LOI ( CC ) \qquad ( 4 )$$

where LOI(CH) is the percentage of Ca(OH)₂ as measured by H₂O loss in this temperature range in the TGA curve, LOI(CC) is the percentage of CaCO₃ with loss of CO₂ in the TGA curve and LOI(CSH) is the percentage of the C—S—H with H₂O loss in the TGA curve.

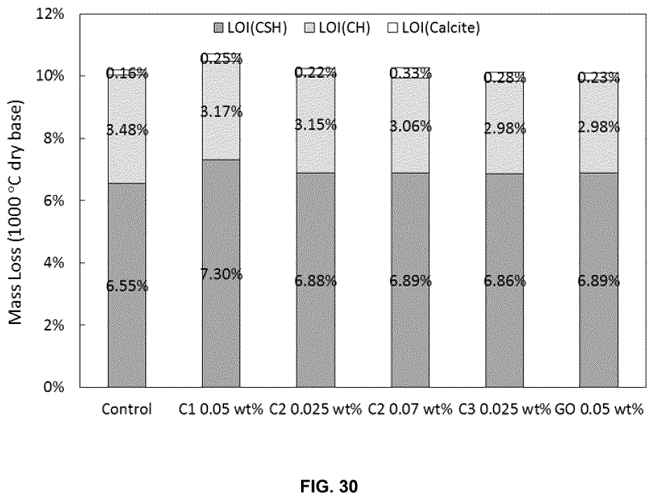

The content of different hydration products, including C—S—H, Ca(OH)₂, and CaCO₃, for cement samples are presented in FIG. 30. The general trend for carbon nanomaterial added cement samples is that the amount of CH decreases, whereas the amount of both C—S—H and CaCO₃ increases. The reduction of CH could be caused by the reaction of COO⁻ on the edge of carbon nanosheets with Ca ions to produce Ca(HCOO)₂. The consumption of Ca(OH)₂ can promote the hydration of cement grains and lead to increased amount of C—S—H and CaCO₃. Among different carbon nanomaterials added cement samples, C1 at 0.05 wt. % has the largest increase in the amount of C—S—H by ˜11% (from 6.55% to 7.30%), compared to the control sample. C2 at 0.025 wt. % and 0.07 wt. % and C3 at 0.025 wt. % result in a smaller increase of approximately 5% of the content of C—S—H. C1 is expected to have the most carboxyl groups (COO—) among the three different coal-based carbon nanoadditives because of its synthesis process (and as suggested by the lowest C/O ratio shown in Table 3), which is in agreement with the observations of the improvement on the C—S—H content. Because of the lack of the oxygen-rich functional groups, C2 and C3 lead to significantly reduced consumption of Ca(OH)₂, and thus less promotion of C—S—H formation.

Combining the results of XRD and DSC-TGA, we can conclude that the reinforcing mechanisms of the three coal-based carbon nanoadditives are slightly different. All three carbon nanomaterials can refine the crystalline structure of Portlandite, as indicated by the lowered CH crystalline index R, leading to increased compressive strength. In addition, the oxygen-rich C1 has the ability to promote the hydration process by consuming the calcium ions, which also leads to improved mechanical properties. On the other hand, based on the porosity/permeability test, C2 and C3 are better at refining the pore structure of the cement matrix, in which the additives can fill the cement pores and form a denser structure. With large aspect ratios, C2 and C3 are also much more capable at bridging micro-cracks, leading to improved flexural strength.

Conclusion: Three coal-derived carbon nanomaterials, C1, C2, and C3 were synthesized and examined for their reinforcing effect in cement composites. The nanomaterials were characterized for size, morphology, and elemental composition. When incorporated into cement paste, the mechanical properties, including compressive strength and flexural strength were measured. The durability, including permeability/porosity and chloride penetration, was also evaluated. In addition, the three carbon nanomaterials were applied in concrete samples for their reinforcing effect on mechanical properties. Finaly, the reaction mechanisms of the three carbon nanoadditives were studied with XRD and DSC-TGA. The following conclusions were obtained:

All three types of coal-derived carbon nanomaterials enhance the cement's compressive and flexural strength. The largest improvement for compressive strength was observed with C2 at 0.025 wt. %, representing a 24% increase compared to control cement sample. The largest improvement for flexural strength was observed with both C2 and C3 at 0.01 wt. %, and the enhancement was 23% compared to control samples.

All three types of coal-derived carbon nanomaterials reduced the gas permeability, gas porosity, and chloride ion penetration depth in cement samples. The largest reduction effect was found with C2 at 0.07 wt. %, which reduced the permeability, the porosity and chloride ion penetration by 86%, 36%, and 60%, respectively.

Both the compressive and flexural strength of concrete was improved with the addition of the three different carbon nanomaterials. For mix 1 concrete which in accordance with normal-strength concrete, the highest improvement of compressive strength (21%) was achieved with C2 at 0.02 wt. %, and the highest improvement of flexural strength (19%) was achieved by C3 at 0.02 wt. %. For mix 2 concrete which in accordance of high-strength concrete, the highest improvement of compressive strength (29%) was achieved with C3 at 0.04 wt. %, and the highest improvement of flexural strength (21%) was achieved with both C2 at 0.04 wt. %.

The improvement of mechanical properties and durability of cementitious composites using coal-derived carbon additives were comparable with, or better than, those reported in the literature with graphite-based carbon additives. The low cost and wide abundance of coal feedstocks and high production yield of additives from them could make large scale deployment of this technology more feasible. Additionally, graphite demand will be high in coming years to support battery markets, which will further increase costs and reduce the supply of this more traditional feedstock, further supporting the benefits of utilizing coal.

During the study of the reinforcing mechanisms, all three types of coal-based carbon nanomaterials reduced the CH orientation index R, confirming their ability to refine the crystalline structure of the hydration products, which led to higher compressive strength. In addition, the oxygen rich C1 was found to promote the hydration reaction by consuming the Ca²⁺ and increasing the amount of C—S—H. On the other hand, C2 and C3, with high aspect ratio could fill the cement pores and form a denser structure. The larger C2 and C3 could also bridge microcracks leading to improved flexural strength.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

What is claimed is:

1. A method of using a coal-derived carbon nanomaterial to enhance the physical properties of cement, comprising:
mixing an amount of the coal-derived carbon nanomaterial and a cement formulation, forming a cement suspension,
wherein the carbon nanomaterial is selected from the group consisting of: carbon dots, non-oxidized carbon nanoflakes, oxidized nanoflakes, and combinations thereof; and
curing the cement suspension, forming an enhanced cement.

2. The method of claim 1 further comprising:
producing the coal-derived carbon nanomaterials, wherein producing the coal-derived carbon nanomaterials comprises:
mixing particles of a coal powder and an aqueous solution containing a surfactant, forming a liquid suspension,
wherein the coal powder is produced from a carbon source selected from the group consisting of: raw coal char, graphite, and combinations thereof; and
separating the liquid suspension, producing the carbon nanomaterials from the liquid suspension.

3. The method of claim 2 wherein the particles of coal powder are selected from the group consisting of: oxidized particles of coal powder, non-oxidized particles of coal powder, and combinations thereof.

4. The method of claim 3 wherein the oxidized particles of coal powder are produced by exposing non-oxidized particles of coal powder to an acid selected from sulfuric acid, nitric acid, and combinations thereof.

5. The method of claim 2 wherein the particles of the coal powder are between about 1 μm to about 5 μm in size.

6. The method of claim 2 wherein the surfactant comprises a backbone and side chains comprising acrylate groups.

7. The method of claim 2 wherein the surfactant comprises between about 0.2 wt % to about 1 wt % of the aqueous solution.

8. The method of claim 2 wherein the carbon nanomaterials are selected from the group consisting of: non-oxidized carbon nanoflakes, oxidized carbon nanoflakes, and combinations thereof.

9. The method of claim 2 wherein the carbon nanomaterials are between approximately 70 nm and approximately 500 nm in size.

10. The method of claim 2 wherein said separating step is conducted using centrifugation.

11. The method of claim 2 wherein the centrifugation is conducted at approximately between 500 RPM and 2000 RPM.

12. The method of claim 1, further comprising:
producing the coal-derived carbon nanomaterials, including:
combining particles of a coal powder and an acid, forming an oxidized suspension,
wherein the coal powder is produced from a carbon source selected from the group consisting of: raw coal char, graphite, and combinations thereof, and
wherein combining particles of a coal powder and an acid further comprises heating and stirring the coal powder in the presence of the acid; and
purifying the oxidized suspension, producing the carbon nanomaterials from the oxidized suspension.

13. The method of claim 12 wherein the particles of the coal powder are between about 5 μm to about 50 μm in size.

14. The method of claim 12 wherein the acid is selected from the group consisting of: nitric acid, sulfuric acid, and combinations thereof.

15. The method of claim 12 wherein the heating occurs at a temperature between approximately 100° C. and approximately 150° C.

16. The method of claim 12 wherein the purifying step comprises neutralizing the oxidized suspension.

17. The method of claim 12 wherein the purifying step comprises filtering the oxidized suspension using cross-flow ultrafiltration.

18. The method of claim 12 wherein the carbon nanomaterials are between approximately 2 nm and approximately 4 nm in size.

19. The method of claim 1 wherein the cement suspension comprises about 0.005 wt. % to about 0.5 wt. % carbon nanomaterial.

20. The method of claim 1 wherein the carbon nanomaterial comprises particles between about 1 nm and approximately 1000 nm in size.

21. The method of claim 1, wherein the coal-derived carbon nanomaterial is mixed with the cement formulation without adding water.

22. The method of claim 1, wherein the method yields an enhanced cement with an increase in compressive strength of between about 4% to about 24% compared to a cement formulation without the coal-derived carbon nanomaterial.

23. The method of claim 1, wherein the method yields an enhanced cement with an increase in flexural strength of between about 2% to about 22% compared to a cement formulation without the coal-derived carbon nanomaterial.

24. The method of claim 1, wherein the method yields an enhanced cement with a decreased permeability of between about 35% to about 86% compared to a cement formulation without the coal-derived carbon nanomaterial.

25. The method of claim 1, wherein the method yields an enhanced cement with a decreased chloride penetration depth of between about 40% to about 60% compared to a cement formulation without the coal-derived carbon nanomaterial.

26. An enhanced cement comprising:
a coal-derived carbon nanomaterial;
and a cement formulation.

27. The enhanced cement of claim 26, wherein the coal-derived nanomaterial is selected from the group consisting of: carbon dots, non-oxidized carbon nanoflakes, oxidized nanoflakes, and combinations thereof.

28. The enhanced cement of claim 26, wherein the coal-derived nanomaterial are between approximately 0.01 wt % and approximately 0.35 wt % coal-derived carbon nanomaterial.

29. The enhanced cement of claim 26, wherein the cement formulation comprises a water to cement ratio of between approximately 0.32 to approximately 0.4.

30. The enhanced cement of claim 26, wherein the cement formulation comprises a sand to cement ratio of between approximately 1.0 to approximately 1.6.
